(19) United States
(12) Patent Application Publication
(10) Pub. No.: US 2025/0238882 A1
(43) Pub. Date: Jul. 24, 2025

(54) FOOD PROVIDING SYSTEM AND EVENT PROCESSING METHOD

(71) Applicant: Kura Sushi, Inc., Osaka (JP)

(72) Inventor: Kunihiko TANAKA, Osaka (JP)

(21) Appl. No.: 18/902,612

(22) Filed: Sep. 30, 2024

(30) Foreign Application Priority Data
Jan. 19, 2024 (JP) 2024-006885
Jul. 2, 2024 (JP) 2024-106903
Aug. 28, 2024 (JP) 2024-146845

(51) Int. Cl. G06Q 50/12; G06Q 10/02

(52) U.S. Cl. CPC G06Q 50/12; G06Q 10/02

(57) ABSTRACT

A food providing system includes a conveying path that extends along customer's tables to convey a holder on which a food or a beverage is placed. The food providing system includes: a storage unit that is configured to store reservation information input by a customer; a seat setting unit that is configured to assign a table to the customer in a restaurant and store seat information on the table in association with the reservation information; a first holder that includes a lid body, the first holder being conveyed on the conveying path with the lid body being closed; and a first holder setting unit that is configured to cause the lid body to open as an event when the first holder passes through the table assigned to the customer.

### CROSS REFERENCE TO RELATED APPLICATION

This application is based on and claims the benefit of priority from Japanese Patent Application No. 2024-006885 filed on Jan. 19, 2024, Japanese Patent Application No. 2024-106903 filed on Jul. 2, 2024, and Japanese Patent Application No. 2024-146845 filed on Aug. 28, 2024. The entire disclosure of the above applications is incorporated herein by reference.

### TECHNICAL FIELD

The present disclosure relates to a food providing system having a conveying path that extends along customer's tables and conveys a holder on which a food or a beverage is placed, and an event processing method using the conveying path.

### BACKGROUND

Restaurants commonly known as conveyor belt sushi restaurants are equipped with food/beverage conveying devices having conveying paths that moves in a circular motion along customer seats. In such restaurants, a staff places a food or a beverage such as sushi on a container, such as a plate, and then moves the plate with the food or beverage onto a conveying path to sequential convey the plate to customers' seats. Customers take, from the conveying path, plates carrying foods or beverages such as sushi that are delivered in sequence to eat the food or drink the beverage.

### SUMMARY

In a restaurant an event such as a family birthday celebration is often held and a special gist is sometimes presented at the event. However, a celebratory event has not been held at a restaurant such as a conveyor belt sushi restaurant having a conveying path, and such an event has been demanded.

The present disclosure has been made to solve the above problem, and one objective of the present disclosure is to provide a food providing system and an event processing method to have an event such as a celebration at a restaurant having a conveying path.

A first aspect of the present disclosure is a food providing system having a conveying path that extends along customer's tables to convey a holder on which a food or a beverage is placed. The food providing system includes: a storage unit that is configured to store reservation information input by a customer; a seat setting unit that is configured to assign a table to the customer in a restaurant and store seat information on the table in association with the reservation information; a first holder that includes a lid body, the first holder being conveyed on the conveying path with the lid body being closed; and a first holder setting unit that is configured to cause the lid body to open as an event when the first holder passes through the table assigned to the customer.

A second aspect of the present disclosure is the food providing system according to the first aspect. The food providing system includes: an image processing unit that is configured to receive at least one of an image and a video for the event from the customer and store the at least one of the image and the video in the storage unit; a second holder that is configured to support a display device while being conveyed on the conveying path; and a second holder setting unit that is configured to cause the display device to display the at least one of the image and the video when the second holder passes through the table assigned to the customer.

A third aspect of the present disclosure is the food providing system according to the second aspect, wherein the first holder and the second holder are conveyed in a row on the conveying path.

A fourth aspect of the present disclosure is the food providing system according to the first aspect. The first holder includes: an actuator that is configured to selectively open and close the lid body based on a setting set by the first holder setting unit, and a battery that is configured to drive the actuator.

A fifth aspect of the present disclosure is the food providing system according to the first aspect, wherein the first holder houses a present that is to be presented to the customer at the event.

A sixth aspect of the present disclosure is the food providing system according to the second aspect. The first holder setting unit is further configured to: control the display device to display the at least one of the image and the video; and then open the lid body.

A seventh aspect of the present disclosure is a method for performing an event on a conveying path that extends along customer's tables and conveys a holder on which a food or a beverage is placed. The method includes: storing reservation information received from a customer in a storage unit; assigning a table to the customer in a restaurant; storing, in association with the reservation information, seat information on the table assigned to the customer; conveying a first holder with a lid body being closed on the conveying path; and opening the lid body when the first holder passes through the table assigned to the customer.

An eighth aspect of the present disclosure is a food providing system with a conveying path that extends along customer's tables and conveys a holder on which a food or a beverage is placed. The food providing system includes: a storage unit that is configured to store reservation information input by a customer; an image processing unit that is configured to receive at least one of an image and a video for an event from the customer and store the at least one of the image and the video in association with the reservation information; a seat setting unit that is configured to assign a table to the customer in a restaurant and store, in association with the reservation information, seat information on the table assigned to the customer; a second holder that is configured to support a display device while being conveyed on the conveying path; and a second holder setting unit that is configured to cause the display device to display the at least one of the image and the video when the second holder passes through the table assigned to the customer.

According to the present disclosure, an event such as a celebration can be held at a restaurant having a conveying path.

### BRIEF DESCRIPTION OF DRAWING

FIG. 1 is a schematic diagram of a food providing system.

FIG. 2 is a cross-sectional view of a conveying path.

FIG. 3 shows a front view of the conveying path.

FIG. 4 shows a front view of a holder in a closed state.

FIG. 5 is a side view of FIG. 4.

FIG. 6 is a front view of a holder in an open state.

FIG. 7 is a side view of FIG. 6.

FIG. 8 is a plan view of a mounting base.

FIG. 9 is a front view of FIG. 8.

FIG. 10 is a side view of FIG. 8.

FIG. 11 is a side view of a lid body.

FIG. 12A is a plan view, FIG. 12B is a side view, and FIG. 12C is a bottom view of an operating element.

FIG. 13 is a side view of the lid body in the closed state and the operating element.

FIG. 14 is a side view of the lid body in the open state and the operating element.

FIG. 15 is a side view of the lid body and the operating element in a closed state of a first holder.

FIG. 16 is a side view of the lid body and the operating element in the open state of the first holder.

FIG. 17 is a front view of the first holder in an open state.

FIG. 18 is a front view showing an event performed by the first holder and a second holder.

FIG. 19 is a block diagram showing a hardware configuration of a restaurant management device.

FIG. 20 is a diagram showing one example of a screen image of a kiosk terminal.

FIG. 21 is a diagram showing one example of a screen image of a kiosk terminal.

FIG. 22 is a diagram showing one example of a screen image of a kiosk terminal.

FIG. 23 is a block diagram showing a hardware configuration of a reception device.

FIG. 24 is a diagram showing one example of a reservation image displayed on a customer terminal.

FIG. 25 is a diagram showing one example of a reservation image displayed on the customer terminal.

FIG. 26 is a diagram showing one example of a reservation image displayed on the customer terminal.

FIG. 27 is a flowchart showing seat allocation when no reservation is made.

FIG. 28 is a flowchart showing seat assignment when a reservation is made.

FIG. 29 is a flowchart of the event.

FIG. 30 is a front view showing another event performed by the first holder and a second holder.

FIG. 31 shows a schematic diagram illustrating other configurations of the display device provided in the second holder.

FIG. 32 is a front view showing another event performed by the first holder and the second holder.

FIG. 33 is a front view showing another event performed by the first holder and the second holder.

FIG. 34 is a front view showing another event performed by the first holder and the second holder.

FIG. 35 is a front view showing another event performed by the first holder and the second holder.

FIG. 36 is a front view showing another event performed by the first holder and the second holder.

FIG. 37 is a front view showing another event performed by the first holder and the second holder.

FIG. 38 is a front view showing another event performed by the first holder and the second holder.

### DETAILED DESCRIPTION OF EMBODIMENTS

### 1. Overview of a food providing system

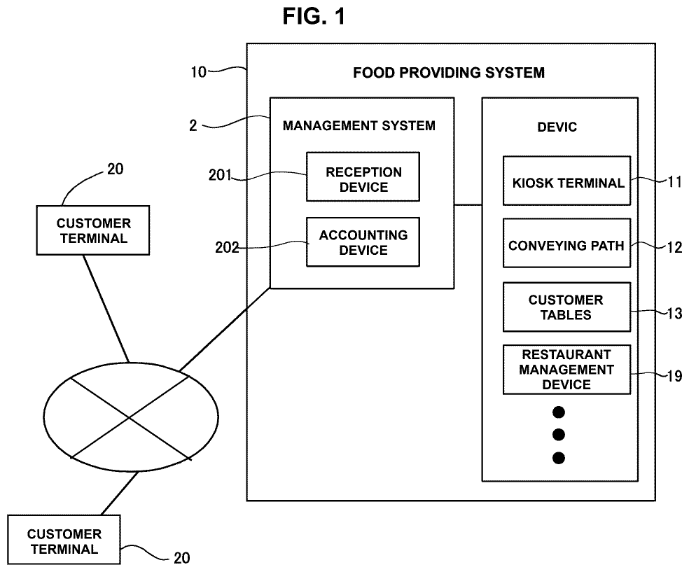

As shown in FIG. 1, a food providing system 10 according to the present embodiment is provided in a sushi restaurant as an example, and includes a kiosk terminal 11 for customers, a conveying path 12 for conveying foods, drinks and beverages, customer tables 13 each having a display, etc., various devices such as a restaurant management device 19, and a management system 2 for managing these devices and for receiving reservations, assigning a table to a customer, and performing accounting or the like. The management system 2 includes a reception device 201 for mainly performing check-in processing for customers and an accounting device 202 for mainly performing accounting processing for customers. Further, the management system 2 is connected to customer terminals 20 via a network such as the Internet, and the customer can make a reservation via the customer terminal 20. The customer terminal 20 may be a known computer such as a smartphone, a tablet computer, or a personal computer. Hereinafter, configuration of each component will be described in detail.

### 2. Devices

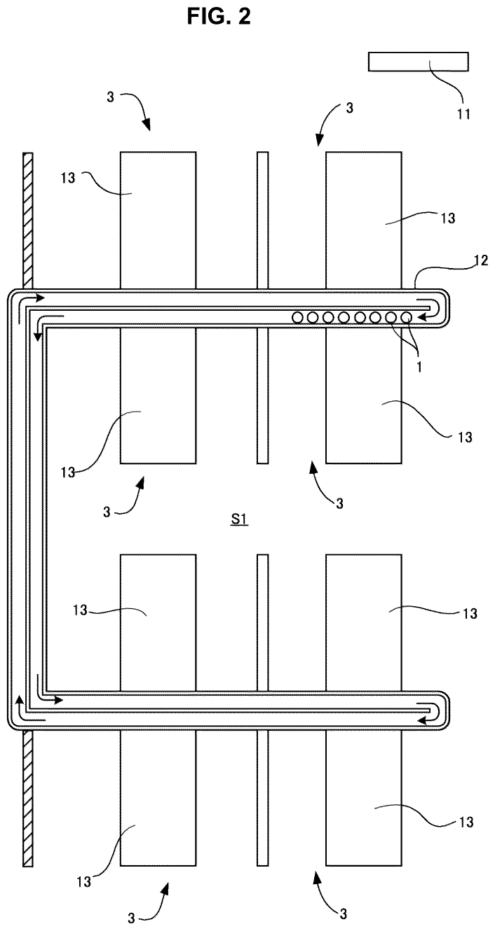

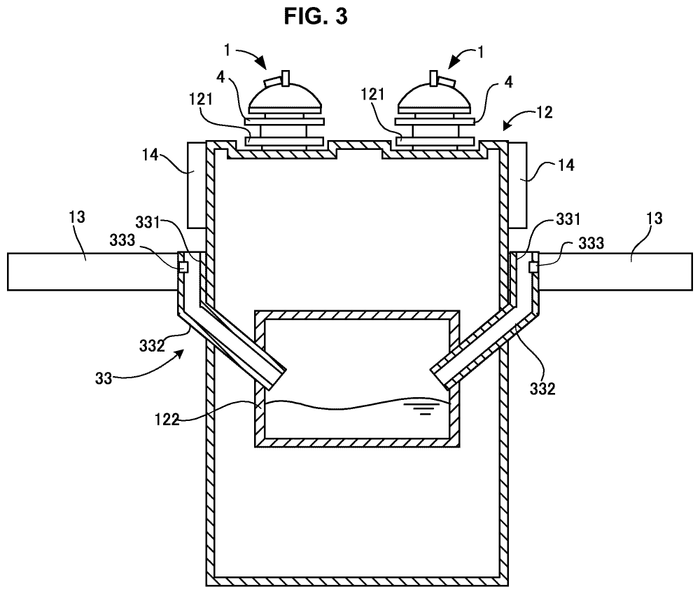

Next, various devices disposed in the restaurant will be described. FIG. 2 is a partial plan view of the restaurant, and FIG. 3 is a cross-sectional view of a conveying path in the restaurant.

### 2-1. Kiosk terminal

As shown in FIG. 2, the kiosk terminal 11 is disposed at the entrance of the restaurant. The kiosk terminal 11 includes a touch panel display. Then, the kiosk terminal 11 performs check-in processing for customers who come in the restaurant without a reservation and customers who come in the restaurant with reservations. Details of check-in processing by the kiosk terminal 11 for customers will be described later.

### 2-2. Tables and conveying path

As shown in FIG. 2, the restaurant is provided with the conveying path 12 for conveying holders 1 for housing a food, a beverage, and/or a beverage between a customer area S1 and a kitchen are S2. The customer area S1 is provided with a plurality of customer seat booths 3 separated by partitions, and the customer seat booths 3 are arranged along the conveying path 12. Further, a rectangular table 13 is disposed in each customer seat booth 3, and one side of the table 13 extends to the conveying path 12.

As shown in FIG. 3, the holder 1 conveyed on the conveying path 12 houses a plate 4 on which a food or a drink (such as sushi, soup, snack, drinks, beverages, etc.) is placed, and the customer of each seat booth 3 takes out the plate 4 with the food or the drink from the holder 1 on the conveying path 12 and eats and drinks at the table 13. The holder 1 is also used for events for customers. The holder 1 will be described later.

A touch panel display 14 through which orders are placed, payments are made, and the like, and a plate collecting device 33 that is configured to collect plates 4 are disposed for the table 31 of each customer booth 3. Hereinafter, each configuration will be described in detail.

A flat chain conveyor 121 is disposed on the conveying path 12, and the flat chain conveyor 121 is circulated between the customer area S1 and the kitchen area S2 by a motor (not shown). The above-mentioned holders 1 are arranged at predetermined intervals on the flat chain conveyors 121 and move along the conveying path 12.

Next, the touch panel display 14 disposed on the table 13 will be described. The touch panel display 14 displays a screen image for accepting an order from a customer. For example, a menu image is displayed, and an order is placed through the touch panel display 14 by touching a food and/or a drink displayed in the menu image. Then, as will be described later, the accounting device 202 counts types and the number of ordered foods and drinks and stores information on the types and the order number therein. These orders are transmitted to the kitchen area S2 and the ordered foods are cooked in the kitchen area S2. Thereafter, the food or the drink according to the order is placed on the plate 4, housed in the holder 1, and conveyed to the customer who placed the order. At this time, an indication for notifying the customer of the ordered food or drink and for indicating the customer who placed the order by using, e.g., the table number for the customer is attached on the holder 1. Alternatively, a specific conveying path that is configured to dedicatedly convey only ordered foods and drinks to customers may be installed in the restaurant.

Next, the plate collecting device 33 will be described. As shown in FIG. 3, the plate collecting device 33 includes a guide path 332 that opens at the table 31 and has an insertion port 331 through which plates 4 are inserted, and a sensor 333 that is provided inside the guide path 332 and detects the plates 4 that are passing through. The guide path 332 extends obliquely downward from the table 13 and is connected to a plate collecting water path 122 provided inside the conveying path 12. The plate collecting water path 22 extends to the kitchen area S2 and is connected to a storage tank (not shown) provided in the kitchen area S2. Water flows through the plate collecting water path 122 toward the storage tank, and when a plate 4 is dropped into the plate collecting water path 122 via the guide path 332, the plate 4 is carried by the water to the storage tank. Then, the plate 4 is collected in the containment tank, cleaned, and reused.

When the plate 4 that has passed through the guide path 332 is detected by the sensor 333, the accounting device 202 updates and stores the number of the plates 4, as will be described later. Further, a message or image for prompting customers to put the plate 4 into the insertion port 331 after eating or drinking may be displayed on the touch panel display 14 or the customer seat booth 3.

### 2-3. holder

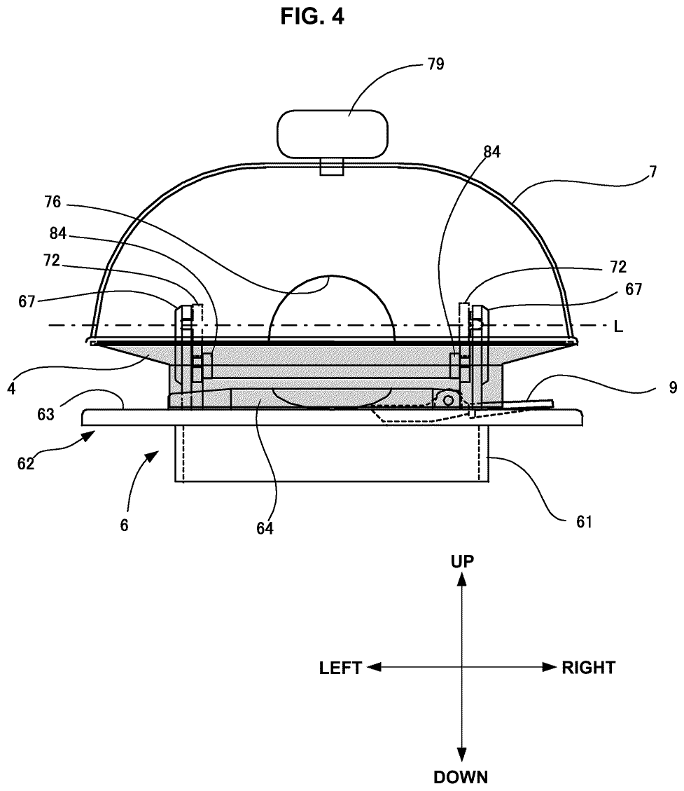

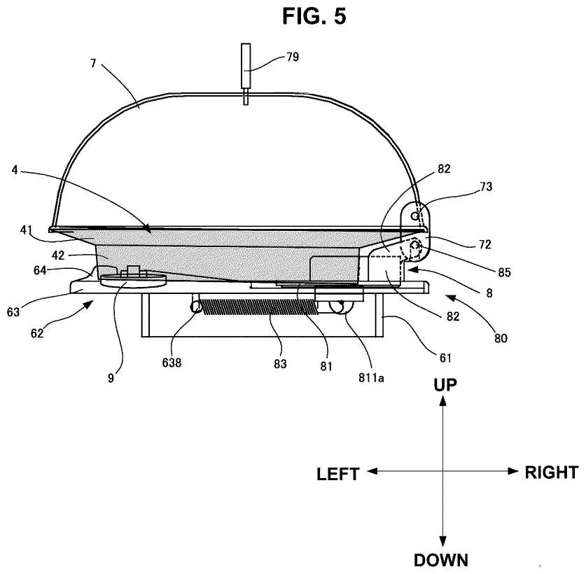

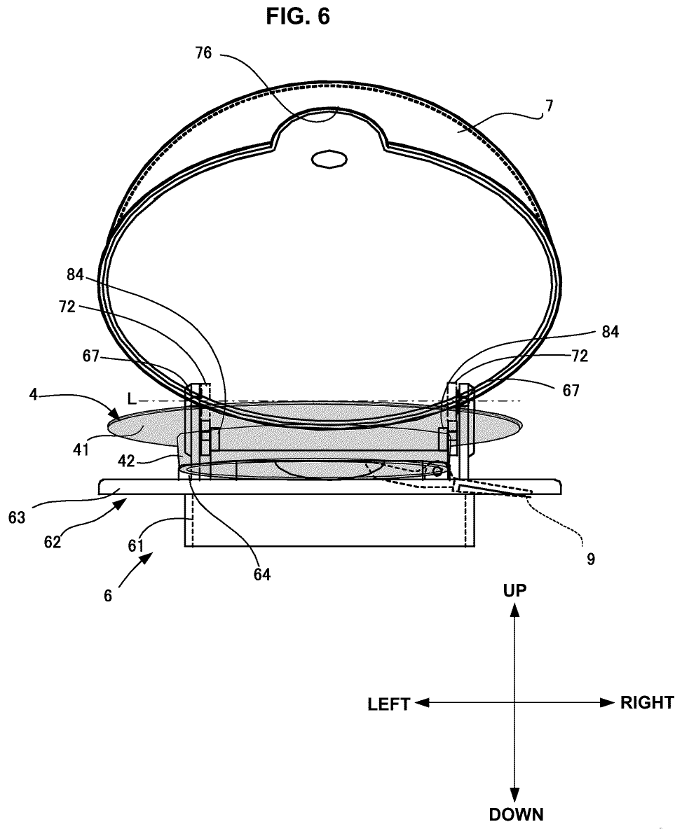

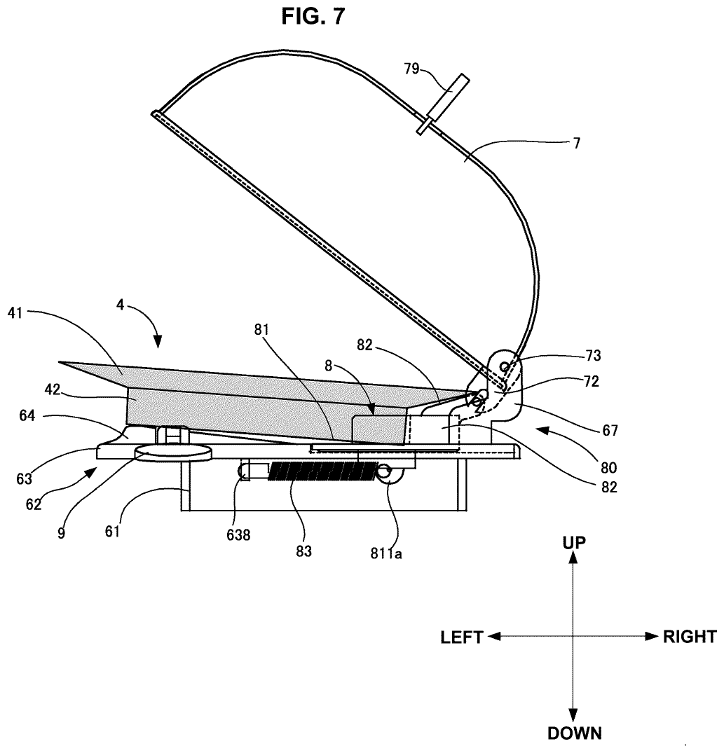

Next, the holder 1 will be described with reference to FIGS. 4 to 7. FIG. 4 is a front view of the holder in a closed state, FIG. 5 is a side view of FIG. 4, FIG. 6 is a front view of the holder in an open state, and FIG. 7 is a side view of FIG. 6. In FIGS. 4 to 7, for convenience only, the plate 4 is shown in colored translucent. In addition to a normal-type holder 1 that houses the plate 4 on which a food or a drink is placed, a first holder 101 and a second holder 102 for events are used as the holder. First, the normal-type holder 1 will be described, and then the first holder and the second holder will be described.

First, the plate 4 housed in the holder 1 will be described. For example, as shown in FIG. 4, the plate 4 includes a plate body 41 having a circular shape in plan view, and a cylindrical base 42 which protrudes downward from a lower surface of the plate body 41. The plate body 41 and the cylindrical base 42 are integrally formed. Then, on the plate 41, a food, a drink, or a beverage such as sushi (not shown) is placed.

Next, the holder 1 will be described. As shown in FIGS. 4 to 7, the holder 1 includes a mounting base 6 having a mounting position at which the plate 4 is placed, a lid body 7 to cover an upper surface of the mounting base 6, and an open/close mechanism 80 to close the lid body 7 when the plate 4 is placed at the mounting position and to open the lid body 7 when the plate 4 is removed from the mounting position. Further, the holder 1 is provided with an operation member 9 for displacing the plate 4 from the mounting position. Hereinafter, each member will be described in detail. For convenience of explanation, the following description will be given based on the directions shown in FIGS. 4 to 7, but the present invention is not limited to these directions.

### 2-3-1. Mounting base

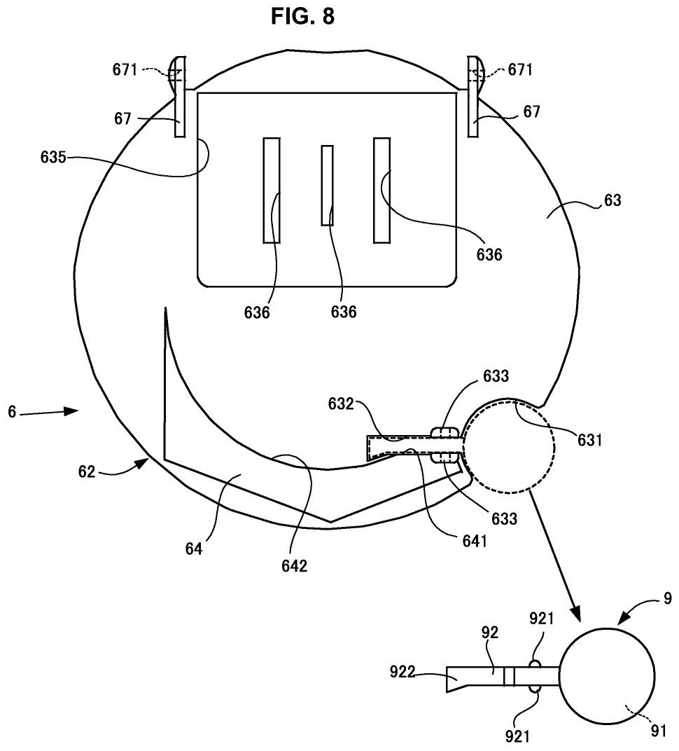

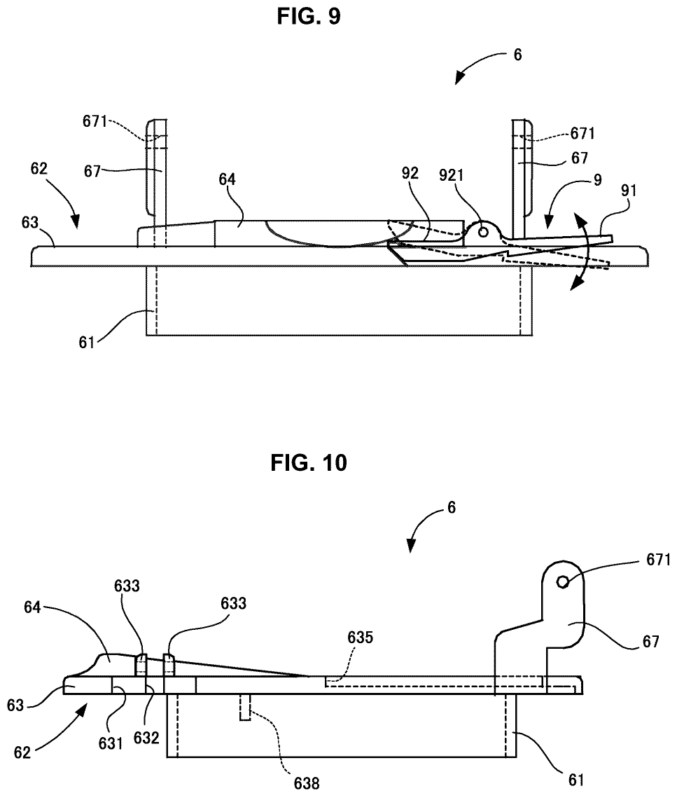

FIG. 8 is a plan view of the mounting base and the operation member, FIG. 9 is a front view of FIG. 8, and FIG. 10 is a side view of FIG. 8. However, in FIG. 8, the operation member 9 is omitted for convenience of explanation. As shown in FIGS. 8 and 9, the mounting base 6 includes a cylindrical base 61 and a mounting portion 62 provided at the upper end of the base 61, which are integrally formed. On the upper surface of the mounting portion 62, the plate 4 is placed, and the plate 4 is held in a mounting position described later. The mounting portion 62 includes a planar circular mounting plate 63, a stopper 64 disposed at the front of the upper surface of the mounting plate 63, and a pair of holders 67 disposed at the rear end of the mounting plate 63 and supporting the lid body 7 so that it can be opened and closed. Further, slightly to the right from the center of the front edge of the mounting plate 63, an arc-shaped first notch 631 and a rectangular second notch 632 extending from the first notch 631 to the left side are formed. The first notch 631 and the second notch 632 are in communication with each other. Then, a pair of mounting pieces 633 to which the operation member 65 described later is attached is provided in the mounting plate 63 so that the right end of the second notch 632 are interposed by the pair of mounting pieces 633 in a front and rear direction,. The pairs of mounting pieces 633 are formed to extend upward from the mounting plate 63, and a through hole is formed near an upper edge of each mounting piece 633.

The stopper 64 protrudes from the mounting plate 63 and extends to the left from the first notch 631 described above along the front edge of the mounting plate 63. Then, a first inner circumferential surface 641 linearly extending along the front edge of the second notch 632, and an arc-shaped second inner circumferential surface 642 that continuously extends from the left end of the first inner circumferential surface 641 to the left of the mounting plate 63 are formed at a rear edge of the stopper 64. The first inner circumferential surface 641 is provided on the right side of the mounting plate 63, and the second inner circumferential surface 642 extend to the center of the mounting plate 60 in the front-rear direction to have a central angle of about 90 degrees. Then, the outer circumferential surface of the base 42 of the plate 4 is in contact with the second inner circumferential surface 642.

Further, on the upper surface of the mounting plate 63, a rectangular recess 635 having a planar view shape is formed behind the center in the front-rear direction, and an operating element 8 described later is disposed in the recess 635. In addition, a plurality of elongated through holes 636 extending in the front-to-rear direction are formed in a bottom surface of the recess 635, and as described below, protrusions 811 of the operating element 8 are inserted into the through holes 636. Accordingly, the base 42 of the plate 4 is clamped between a second inner surface 642 of the stopper 64 and the operating element 8, thereby holding the plate 4 on the mounting base 6. The position at which the plate 4 is held when clamped is referred to as the “mounting position”. FIGS. 4 and 5 show the plate 4 at the mounting position.

As shown in FIGS. 9 and 10, the pair of support pieces 67 described above are attached to the mounting plate 63 to sandwich the recess 635 therebetween, and extend upward from the mounting plate 63. A through hole 671 is formed at the upper end of each support piece 67, and the protrusion 73 of the lid body 7 is rotatably inserted into the through hole 671 so that the lid 7 is capable of being opened and closed. That is, the support pieces 67 serve as a hinge for opening and closing the lid body 7 relative to the mounting portion 62.

### 2-3-2. Operation member

As shown in FIGS. 8 and 9, the operation member 9 includes a circular operation portion 91 and a rectangular lever 92 extending from the operation portion 91 to the left, which are integrally formed. The operation portion 91 is disposed in the first notch 631 described above, and the lever 92 is disposed in the second notch 632. The operation portion 91 protrudes slightly from the first notch 631. Two protrusions 921 each protruding in the front-rear direction from the lever 92 near the right end of the lever 92. The protrusions 921 are rotatably inserted into the through holes of the mounting pierces 633. Thereby, the operation member 9 is able to rotate (or swing) about the protrusions 921. In an initial state, as shown by the solid line in FIG. 9, the lever 92 is substantially housed in the second notch 632, and the operation portion 91 is located slightly above the first notch 631. Then, when the operation portion 91 is pushed downward from the initial state, as shown by the dashed line in FIG. 9, the lever 92 rotates upward to have the left end of the lever 92 higher than the second notch portion 632 (i.e., higher than the upper surface of the mounting plate 63).

Further, the front edge of the lever 92 is formed along the first inner circumferential surface 641 of the stopper 64. Only the front edge of the tip portion 922 of the lever 922 is formed along the second inner circumferential surface 642. However, the length of the tip portion 922 in a left-right direction is small, and is located on the right side of the center of the mounting plate 63.

### 2-3-3. Lid body

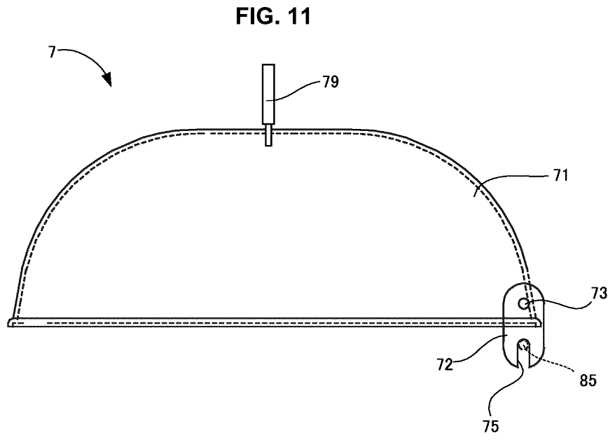

FIG. 11 is a side view of the lid. As shown in FIG. 11, the lid body 7 includes a dome-shaped main body 71 and a pair of left and right arm pieces 72 extending downward from a rear end of the main body 71, which are integrally formed. The main body 71 and the arm pieces 72 are made of a transparent synthetic resin material, so that the inside can be seen from an outside. The above-mentioned protrusions 73 are formed near an upper end of each arm piece 72, and each protrusion 73 is rotatably fitted into the through hole 671 of the support piece 67 of the mounting portion 62. Each protrusion 73 protrudes in the left-right direction, which allows the lid body 7 to rotate about a pivot axis L (see FIG. 4, etc.) that passes through both the protrusions 73 and extends in the left-right direction, thereby making it possible to open and close the lid body 7 relative to the mounting plate 63.

Further, at the lower end of each arm piece 72, an elongated notch 75 extending upward is formed. A connecting shaft 85 of the operating element 8 (described later) is inserted into the notches 75.

The outer diameter of the lid body 7 is approximately the same as the outer diameter of the mounting plate 63, and as shown in FIG. 4, when the lid body 7 is in the closed state, the lower edge of the lid body 7 is positioned above a circumferential edge of the mounting plate 63 with a space. The plate 4 is housed in this space. Furthermore, as shown in FIG. 4, an arc-shaped cutout 76 is formed in the lower edge of the front portion of the lid body 7, and the plate 4 housed therein can be grasped through the cutout 76. A through hole 77 is formed at the top of the lid body 7, and a display tag 79 indicative of the type of housed food or drink is attached in the through hole 77. The display tag 79 can display or indicate the type of sushi, such as tuna, sea bream, etc.

### 4-3. Open/close mechanism

Next, the open/close mechanism will be described. As shown in FIGS. 5 and 7, the open/close mechanism 80 includes the operating element 8 disposed on the mounting plate 63, and a coil spring (biasing means) 83 for biasing the operating element 8 forward.

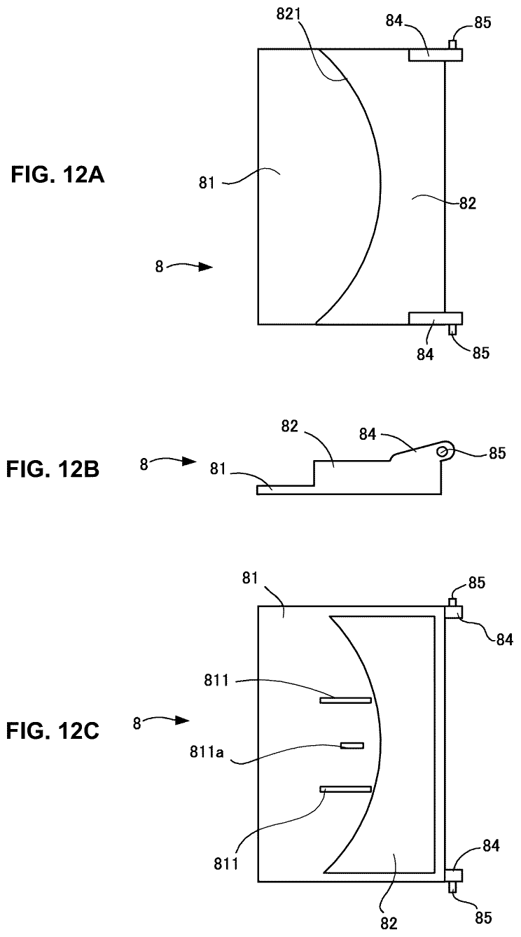

First, the operating element 8 will be described. FIG. 12A is a plan view, FIG. 12B is a side view, and FIG. 12C is a bottom view of the operating element. As shown in FIG. 12A to 12C, the operating element 8 is disposed in the recess 635 of the above-mentioned mounting plate 63 and includes a plate-shaped main body portion 81 which slides in the front-rear direction within the recess 635, and a support portion 82 which protrudes upward from the rear end of the main body portion 81. The support portion 82 is formed in a rectangular shape in plan view. The support portion 82 has an inner surface 821 at the front of the support portion 82. The inner surface 821 is concave in an arc shape toward the rear, and the inner surface 821 is in contact with the outer surface of the base 42 of the plate 4. That is, the base 42 of the plate 4 is interposed between the inner surface 821 of the operating element 8 and the second inner surface 642 of the stopper 64.

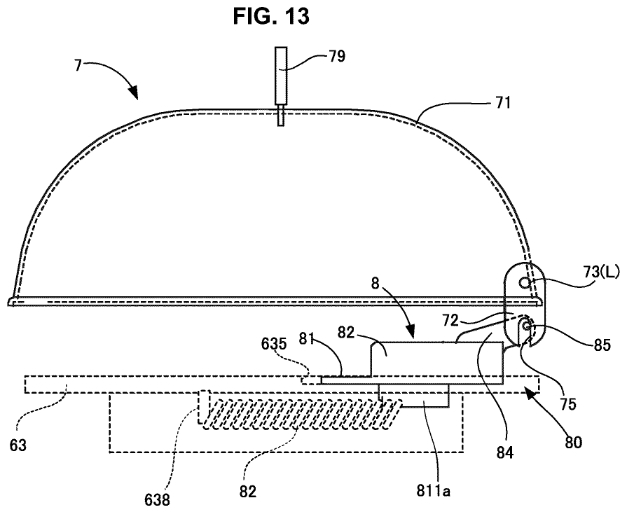

As shown in FIG. 12C, a plurality of protrusions 811 extending in the front-rear direction are formed on a lower surface of the main body 81, and these protrusions 811 are fit into the through holes 636 formed in the bottom surface of the recess 635 of the mounting plate 63, as described above. As a result, the main body 81 is able to slide in the front-rear direction while being guided by the protrusions 811 and the through holes 634. As shown in FIG. 5, etc., the above-mentioned coil spring 83 is attached between the central protrusion 811a in the left-right direction among the protrusions 811 and an attachment portion 638 formed on the lower surface of the mounting plate 63 at a position frontward of the protrusion 811a. The coil spring 83 constantly biases the operating element 8 forward. However, as shown in FIG. 13 described later, the main body 81 of the operating element 8 is disposed in the recess 635 of the mounting plate 63, and a front wall of the recess 635 acts as a stopper. Therefore, the main body 81 is restricted from moving forward by the front wall of the recess 635 although the main body 81 is biased forward by the coil spring 83.

As shown in FIGS. 12A-12C, protrusions 84 are formed on both sides of the rear end of the support portion 82 to extend obliquely upward toward the rear side. A connecting shaft 85 extending in the left-right direction is formed near the upper end of each protrusion 84, and each connecting shaft 85 is inserted into the notch 75 formed in the arm piece 72 of the cover body 7 and is capable of moving within the notch 75. The connecting shaft 85 is inserted into the notch 75 at a position below the pivot axis L.

Next, operation of the lid body by the operating element will be described below. FIG. 13 shows the lid in a closed state, and FIG. 14 shows the lid in an open state. FIGS. 13 and 14, the cover body 7 and the operating element 8 are mainly shown, and for the sake of convenience, the support pieces 67 of the mounting base 6 are omitted.

The operating element 8 is constantly biased forward by the coil spring 83, and therefore, as shown in FIG. 13, the operating element 8 is in contact with the front wall of the recess 635 when no external force is applied to the operating element 8. As a result, the connecting shafts 85 push the lower ends of the arm pieces 72 forward. That is, the connecting shafts 85 press the lower ends of the arm pieces 72 forward at a position below the pivot axis L, so that the lid body 7 rotates upward about the pivot axis L to open. Since the operating element 8 is constantly biased forward by the coil spring 83, the lid body 7 is in the open state as default as shown in FIG. 13.

From this state, when the operating element 8 is moved rearward against the coil spring 83, the connecting shafts 85 push the arm pieces 72 rearward, as shown in FIG. 14. As a result, the lid body 7 is pressed rearward at a position below the pivot axis L, so that the lid body 7 rotates downward about the pivot axis L to be closed as shown in FIG. 12. In this process, the connecting shafts 85 moves upward within the notches 75 of the arm pieces 72. In addition, the specific configuration of the open/close mechanism may be modified in various ways, and for example, the open/close mechanism described in JP 2022-016238 A, which is incorporated herein by reference, may be used.

### 2-3-5. Usage of the holder

Next, a method of using the holder 5 will be described. First, a staff places food or drink (not shown) such as sushi on the plate body 41 of the plate 4, then holds the circumferential edge of the plate body 41 with his/her hand to place the plate 4 on the opened holder 1 on the conveying path 12. That is, from the state shown in FIG. 7, the plate 4 is pushed backward against the mounting plate 63. At this time, the base 42 of the plate 4 is brought into contact with the inner surface 821 of the operating element 8, and the plate 4 together with the operating element 8 is pressed backward. Then, when the base 42 of the plate 4 is engaged with the second inner surface 642 of the stopper 64, the base 42 is held (or set) between the operating element 8 and the stopper 64. At this time, the lever 92 of the operation member 9 is pushed downward to the base 42. During this process, the operating element 8 moves rearward, so that the lid body 7 rotates downward to be closed, as shown in FIGS. 4 and 5. As a result, since the top of the plate 4 is covered with the lid body 7, the sushi is protected by the lid body 7 and dust and the like are prevented from adhering thereto. However, since the lid body 7 is transparent, the sushi inside the holder can be seen from the outside. In addition, since the operating element 8 is biased forward by the coil spring 83, the base 42 of the plate 4 is pressed by the operating element 8. Therefore, the base 42 is firmly held between the operating element 8 and the stopper 64. Accordingly, the lid body 7 is maintained in the closed state and will not open accidentally.

The holder 1 with the plate 4 is conveyed along the conveying path 12, and a customer removes the plate 4 from the holder 1 at the table 13. Hereinafter, this operation will be described.

The customer can take out the plate 4 from the holder 1 in two ways. The first method is a method of pressing the operation portion 91 of the operation member 9. When the customer pushes the operation portion 91 downward from the states illustrated in FIGS. 4 and 5, the lever 92 pushes the base 42 upward at the position near the stopper 64 as shown in FIG. 6. Thereby, when the base 42 is moved away from the stopper 64, the base 42 is pushed forward by the actuator 8 that is biased by the coil spring 83. During this process, the operation portion 8 moves forward so that the lid body 7 rotates upward to open as shown in FIGS. 6 and 7. In this way, the customer can remove the plate 4 from the holder 1 while still holding the plate body 41.

In the other way, from the state shown in FIG. 4 and FIG. 5, a finger of a customer is inserted through the notch 76 of the lid body 7, and the plate body 41 is grasped with the finger and pushed upward by the finger. As a result, when the base 42 is released from the stopper 64, the base 42 is pushed forward by the operating element 8. During this process, the operating element 8 moves forward, causing the lid body 7 to rotate upward to open. In this way, the customer can remove the plate 4 from the holder 1 while still holding the plate body 41.

### 2-3-6. First and second holders for events

The holder 1 described above is configured so that the customer opens the lid by his/her own operation, but the first holder 101 for events is configured so that the lid is opened by the restaurant.

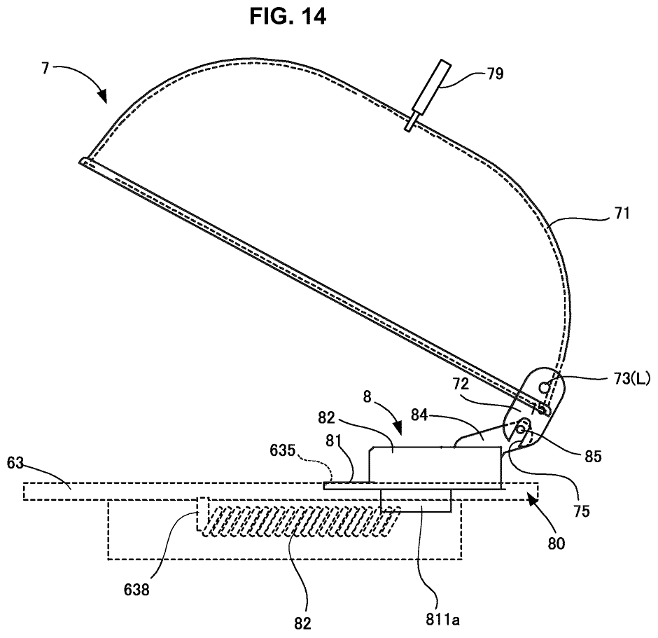

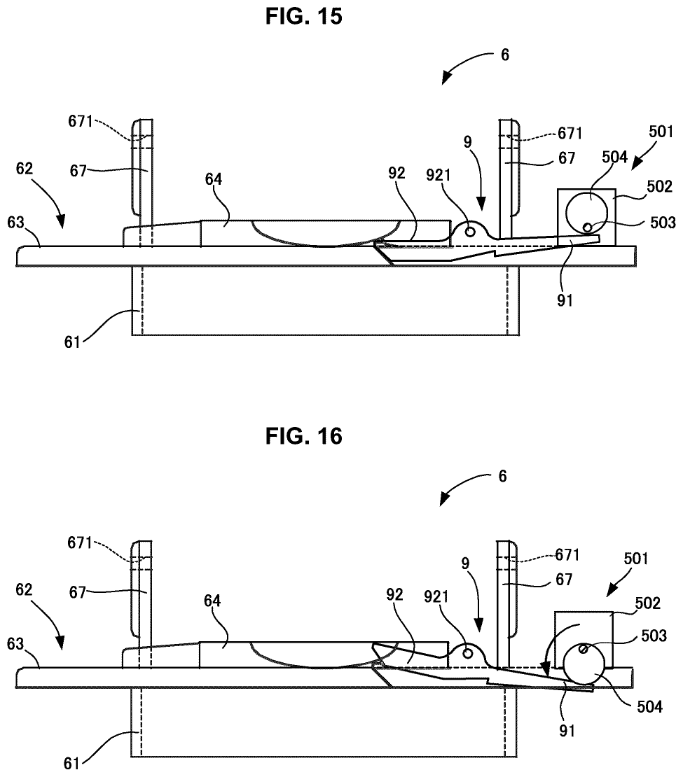

FIG. 15 is a front view showing a mounting base of the first holder 101. As shown in the figure, the mounting base 6 differs from the normal holder 1 described above in that the operation member 9 is performed by a machine (not a customer). An actuator 501 is provided at an edge of the mounting plate 63 of the mounting base 6, and the actuator 501 presses the operation portion 91 of the operating member 9. The actuator 501 includes a rectangular housing 502 in which a motor is built-in, a rotation shaft 503 protruding from the front surface of the housing 502, and a disk 504 connected to the rotation shaft 503. The rotation shaft 503 is connected to the disk at a position offset from the center of the disk 504.

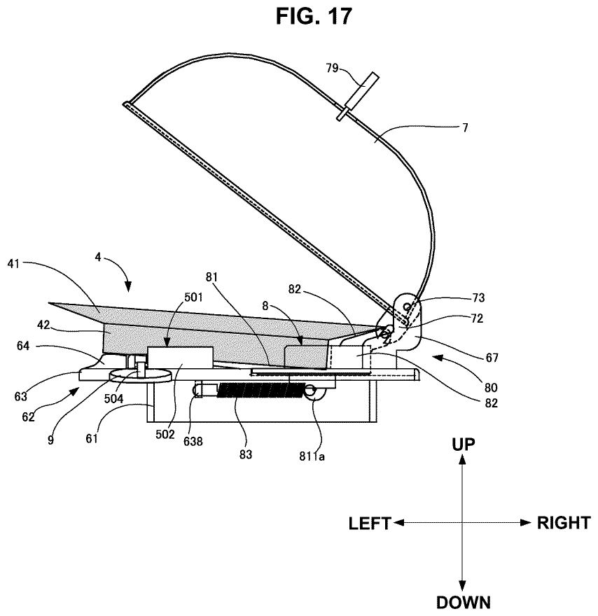

As shown in FIG. 15, when the operation member 9 is in a first state, the outer circumferential surface of the disk 504 is in contact with the operation portion 91, but when the rotation shaft 503 rotates, as shown in FIG. 16, the disk 504 pushes the operation portion 91 downward while rotating. As a result, since the operation member 9 changes to a second state, the lid body 7 opens and the plate 4 is pushed forward as shown in FIG. 17.

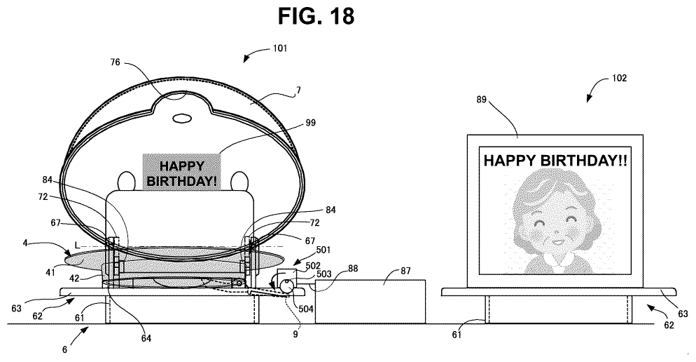

As shown in FIG. 18, the first holder 101 is connected to a control unit 87 for driving an actuator 501A. The control unit 87 has a rectangular housing and is connected to the first holder 101 by a cable 88. The control unit 87 is disposed behind the first holder 101 and both are conveyed in a row on the conveying path 12. Further, the second holder 102 is connected to the control unit 87. That is, on the conveyance path 12, the first holder 101, the control unit 87, and the second holder 102 connected by a connector 800 are conveyed in a row in this order. However, since each of the holders 1 is placed on the conveyance path 12 and conveyed, they are generally conveyed at predetermined intervals, but when it is necessary to reliably convey the holders 1 at predetermined intervals, it is preferable to connect them with the connector 800.

The control unit 87 includes a micro-computer such as a PLC for driving the motor of the actuator 501, a communication unit for wireless communication with the restaurant management device 19, and a battery for driving the actuator 501. The communication unit communicates with the restaurant management device 19 by a communication method such as WiFi, and when an event start signal is received from the restaurant management device 19 as described later, the motor is driven by the computer to open the lid body 7.

As shown in FIG. 18, a present or food 99 (hereinafter, simply referred to as a “present 99”) such as a cake is placed on the plate 4 of the first holder 101. Further, the lid body 7 of the first support may be colored so that the present 99 inside is not visible until the lid body 7 is opened.

The second holder 102 is disposed behind the control unit 87 and is conveyed together with the first holder 101 and the control unit 87 on the conveying path 12. The second holder 102 has a mounting base 6 as with the first holder 101. Then, a display device 89 for displaying an image is disposed on the mounting base 6. The display device 89 can be a tablet computer, a smartphone, a projector for a 3D hologram, or the like. As will be described later, the display device 89 is configured to display, at a predetermined timing, a processed image transmitted from the restaurant management device 19. Further, when a tablet computer or a smartphone is used as the display device 89, it is also possible to output an audio voice from a speaker built into the tablet or the smartphone at the time of the event. When the display device 89 is a projector without a built-in speaker, a speaker can be provided separately on the second holder 102. The audio voice output from the speaker may use audio data stored in a tablet computer or the like in advance, or may transmit audio data from the restaurant management device 19.

### 2-4. Restaurant management device

The restaurant management device 19 manages various devices of the restaurant. The restaurant management device 19 manages various devices in the restaurant, such as, for example, driving control for the conveying path 12 and control for the first and second holders 101, 102 for events.

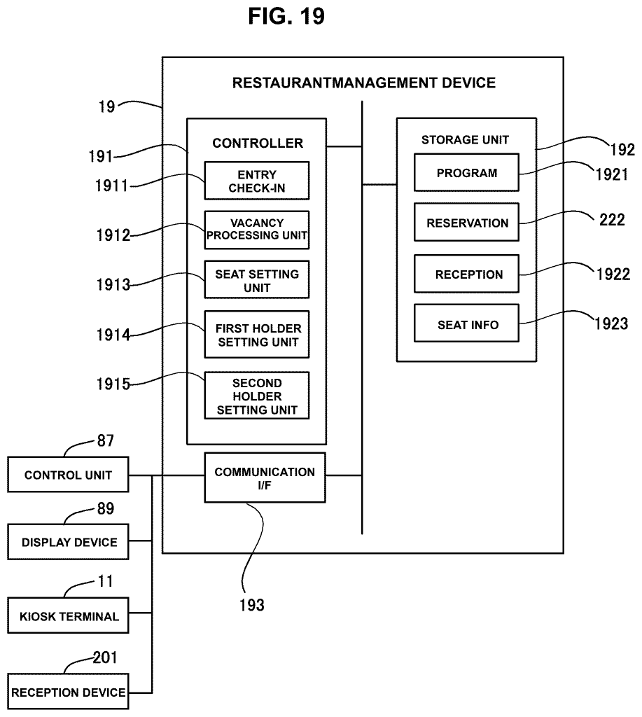

FIG. 19 is a block diagram of the restaurant management device. As shown in FIG. 19, the restaurant management device 19 is a computer to which a controller 191, a storage unit 192, a communication interface 193, and the like are electrically connected.

The controller 191 includes a CPU (Central Processing Unit), RAM (Random Access Memory), ROM (Read Only Memory), and the like, and performs various processes for customer reception. Details will be described later. The storage unit 192 is, for example, an auxiliary storage device such as a hard disk drive or a solid-state drive, and stores information such as a program 1921 executed by the controller 21, reservation information 222, check-in information 223, and seat information 224.

The communication interface 193 is, for example, a wired LAN (Local Area Network) module, a wireless LAN module, or the like, and is an interface for performing wired or wireless communication. That is, the communication interface 193 is an example of a communication unit configured to communicate with other devices. The reception device 201 of the present embodiment is connected to various devices in the restaurant, such as the control unit 87 of the first holder 101, the display device 89 of the second holder 102, and the kiosk terminal 11 via the communication interface 23 and the Internet. In the present embodiment, the control unit 87 of the first holder 101 and the display device 89 of the second holder 102 and the restaurant management device 19 are wirelessly connected to each other and transmit control signals and data therebetween. Further, the reception device 201 described later is also connected to these devices via a network such as the Internet or a dedicated line. In addition, communication via a local network in the restaurant other than the Internet may be used.

In addition, although the illustration is omitted, a display device such as a display or a touch panel display, an input device such as a keyboard or a mouse, and the like are connected to the restaurant management device 19.

Next, the functional structure (software structure) of the restaurant management device 19 will be described together with a procedure from check-in by a customer to guidance for the customer to a seat. The controller 191 of the restaurant management device 19 deploys the program 1921 stored in the storage unit 192 into the RAM. Then, the controller 191 interprets and executes the program 1921 deployed in the RAM by the CPU to control each component. As a result, as shown in FIG. 19, the restaurant management device 19 according to the present embodiment functions as a computer including an entry check-in unit 1911, a vacancy processing unit 1912, a seat setting unit 1913, a first holder setting unit 1914, and a second holder setting unit 1915. Hereinafter, these functional configurations will be described.

First, the restaurant management device 19 receives reservation information 222 on a customer's reservation from the reception device 201 described later, and stores the information 222 in the storage unit 192. Details of the reservation information 222 will be described later.

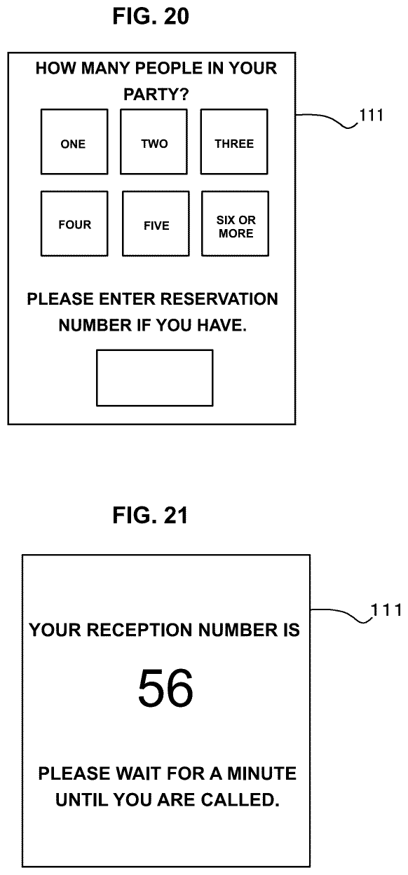

The entry check-in unit 1911 performs the following processing at the kiosk terminal 11 to address the check-in for a customer. As shown in FIG. 20, a check-in image is displayed on a touch panel display 111 of the kiosk terminal 11. Through the check-in image, both a customer who enters the restaurant without a reservation and a customer who enters the restaurant with a reservation can make a check-in procedure. Customers who enter the restaurant without a reservation are asked to enter the number of persons. Then, when the customer touches the number of persons on the image, for example, as shown in FIG. 21, the check-in is completed and a reception number is displayed. Then, the reception number is stored as reception information 1922 in the storage unit 192 of the restaurant management device 19 in association with the number of customers. Further, the kiosk terminal 11 may print out a paper on which the reception number is printed and provide the paper to the customer.

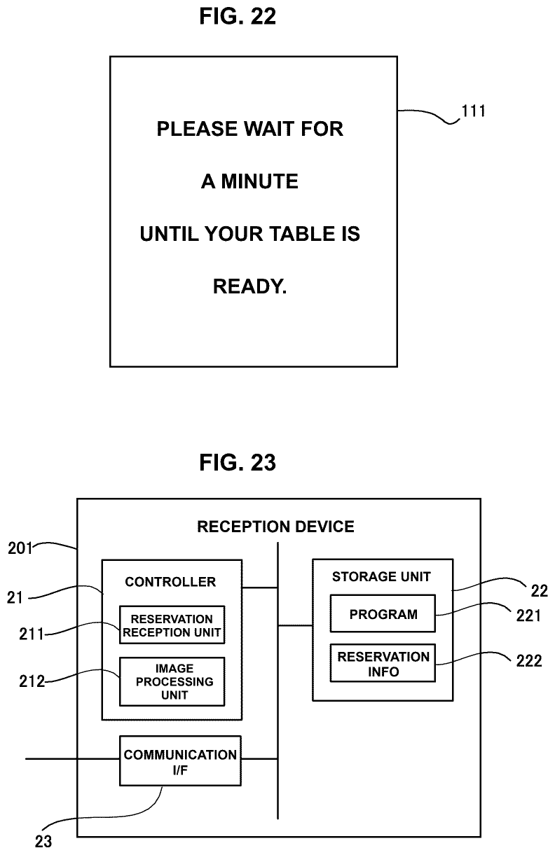

On the other hand, the customer who has made a reservation enters a reservation number in the check-in image shown in FIG. 20. The reservation number is a number given at the time of making a reservation as described below. As a result, the image shown in FIG. 22 is displayed on the touch panel display 111 and the customer(s) waits until guidance. When the reservation number is entered, the entry check-in unit 1911 adds a flag to the reservation information 222 that the entry to the restaurant by the customer has been done, and stores the flag in the storage unit 22.

When any of the tables 13 in the restaurant becomes vacant, the vacancy processing unit 1912 performs the following processing. Seat information 224 is assigned to each table 13. The seat information 1923 includes a table number, a capacity, a table type, a flag indicative of a vacant seat, and the like, and the seat information 1923 is stored in the storage unit 192. Then, when a customer finishes eating and drinking and leaves the table 13, a restaurant staff cleans the table 13. At this time, the staff can clean up the inside of the insertion port 331 by opening a door (not shown). At this time, when the door is opened, the vacancy processing unit 1912 determines that the table is in a cleaning state, and when the door is closed after the cleaning is completed, the vacancy processing unit 1912 adds, to the seat information, a flag indicating that the table 13 is vacant and stores the flag in the storage unit 192. Thus, the storage unit 192 stores the information from which vacancy of each table 13 is recognized. A cleaning completion button is preferably disposed in the table at a position where the button is not visible to customers so that the customers do not accidentally press the button. For example, the button may be provided inside the insertion port 331 of the plate collecting device 33. Further, the method of setting information that the cleaning has been completed, that is, that the table 13 has become vacant, is not necessarily limited to this, and in addition to opening and closing the door as described above, such information may be input through the touch panel display 14 installed in the table 13 by a restaurant staff, for example.

The seat setting unit 1913 performs the following processing to guide a customer to a vacant seat. That is, the seat setting unit 1913 refers to the seat information 1923, and if there is a vacant seat, the seat setting unit 1913 associates the reception information 1922 with the seat information 1923 related to the vacant table 13 in a predetermined order. For example, if the number of persons for the vacant table 13 and the number of the customers in the reception information 1922 match, the customer associated with the reception information 1922 is guided to the table 13. The method of guiding the customer to the table 13 is not particularly limited. For example, the reception number under the guidance and the number of the target table 13 may be announced from a restaurant's speaker. In addition, a display (not shown) displaying the reception number and the number of the target table may be used, a customer may use a restaurant terminal device lent by the restaurant to be notified that the customer will be guided soon, or the customer may be guided by a restaurant staff.

However, the order of guidance is not particularly fixed, and even if the order in which the reception information 1922 for customers receives the check-in late, but the number of persons for the vacant table 13 and the number of the customers in the reception information 1922 match, these customers may be guided earlier than other customers who made check-in earlier. Further, regardless of the above-described check-in order, customers who have reservation information 222 are guided within a scheduled guidance time displayed as reservation contents. That is, a vacant seat corresponding to the number of reserved customers is secured by the end of the scheduled guidance time as much as possible, and when the entry flag is added to the reservation information 222, the set setting unit 1913 associates the reservation information 222 with the seat information 1923, stores the associated information 222, 1923, and performs guidance for the customers.

Based on the reservation information 222, the first holder setting unit 1914 sets an event start signal to be transmitted at a timing so that the lid body 7 opens when the first holder 101 passes through the table 13 assigned to the customer. In this case, the first holder setting unit 1914 (i.e., the controller 191) performs a first event step of opening the lid body 7 when the first holder 101 passes through the table (hereinafter, referred to as a “target table”) assigned to the customer who requests the event based on the seat information associated with the reservation information 222 and stored in the storage unit 192.

Based on the reservation information 222, the second holder setting unit 1915 sets an image or the like to be displayed on the display device 89 at a timing the second holder 102 passes through the target table 13. That is, the second holder setting unit 1915 (i.e., the controller 191) transmits an image or the like associated with the reservation information 222 to the display device 89 at the above-described timing. In this case, the second holder setting unit 1915 (i.e., the controller 191) performs a second event step of causing the display device 89 to display at least one of an image or a video when the second holder 102 passes through the target table assigned to the customer based on the seat information and at least one of the image and the video that are stored in the storage unit 192. Further, as will be described later, audio data may be transmitted to the display device 89 to output an audio voice corresponding to the event reserved by the customer from the speaker of the display device 89.

### 3. Management system

Next, the management system 2 will be described. As shown in FIG. 1 described above, the management system 2 includes the reception device 201 and the accounting device 202. First, the reception device 201 will be described.

### 3-1. Reception device

FIG. 23 is a block diagram of the reception device. As shown in FIG. 23, the reception device 201 is a computer to which a controller 21, a storage unit 22, a communication interface 23, and the like are electrically connected.

The controller 21 includes a CPU (Central Processing Unit), a RAM (Random Access Memory), a ROM (Read Only Memory), and the like, and performs various processes for customer reception. Details will be described later. The storage unit 22 is, for example, an auxiliary storage device such as a hard disk drive or a solid-state drive, and stores information such as a program 221 executed by the controller 21 and reservation information 222.

The communication interface 23 is, for example, a wired LAN (Local Area Network) module, a wireless LAN module, or the like, and is an interface for performing wired or wireless communication. That is, the communication interface 23 is an example of a communication unit configured to communicate with other devices. The reception device 201 of the present embodiment can be connected to the customer terminals 20 via the communication interface 23 and the Internet. Further, the reception device 201 is also connected to various devices disposed in the restaurant, such as the restaurant management device 19 as described above. In addition, communication via a local network between restaurants other than the Internet may be used.

Next, the functional configuration (software configuration) of the reception device 201 will be described together with the procedure from check-in by a customer to guidance for the customer to a seat. The controller 21 of the reception device 201 deploys the program 221 stored in the storage unit 22 into the RAM. Then, the controller 21 interprets and executes the program 221 deployed in the RAM by the CPU to control each component. Thereby, as shown in FIG. 23, the reception device 201 according to the present embodiment functions as a computer including a reservation reception unit 211 and an image processing unit 212. Hereinafter, these functional configurations will be described.

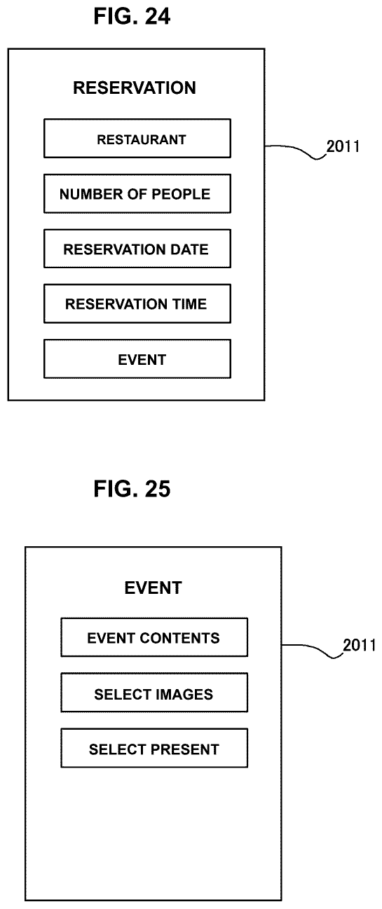

The reservation reception unit 211 performs the following processing to accept reservations from the customer terminals 20. For example, as shown in FIG. 24, a reservation image is displayed on a display 2011 of the customer terminal 20, and the customer enters the restaurant name, the number of persons for reservation, the reservation date, the reservation time, and the event through the reservation image. When an event is requested, the customer inputs information on the event as shown in FIG. 25. As shown in FIG. 25, buttons related to event contents, selection of images, and selection of presents are displayed on an input image for the event information.

When the event content button is touched, for example, event contents such as a birthday, a wedding anniversary, an entrance celebration of a school, a graduation celebration of a school, and other celebrations are displayed on a pull-down menu, and the event content is selected from the menu. At the selection of images, the customer selects an image to be displayed at the event. More specifically, an image for the event to be displayed on the display device 89 of the second holder 102 as described above is selected. For example, when celebrating a family member's birthday as an event, a family photo (i.e., a photo image) owned by the customer stored in the customer terminal 20 may be selected. Thereby, the image data of the selected photograph is transmitted to the storage unit 22 of the reception device 201. When an image is not selected by the customer, one of images suitable for the event content is automatically selected by the reception device 201. In addition to images, customers may also select a video. That is, at least one of an image and a video may be selected. Further, a plurality of images and videos may be selected. Furthermore, although not illustrated, letters such as a message to be displayed at the event, audio data for music used in the event, and the like may also be input. Alternatively, the customer may select images, videos, letters, audio data, and the like for the event that have been stored in the reception device 201, or these options may be automatically selected by the reception device 201.

When the present selection button is touched, candidates for presents to be housed in the first holder 101 is displayed by a pull-down menu, and one of presents is selected from the menu. As present candidates, in addition to foods such as cakes, various presents may be displayed. In addition, some of presents may be charged, and in that case prices for the presents may be also displayed.

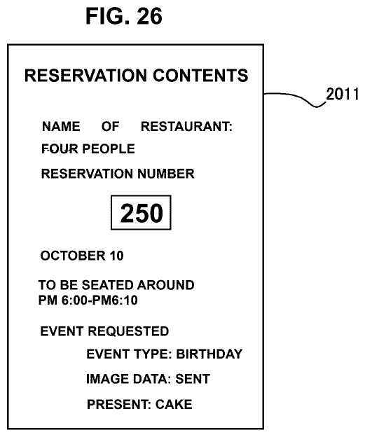

When the reservation is completed, the reservation contents are displayed on the display 2011 as shown in FIG. 26. A reservation number (reservation identification information) is displayed in this reservation contents, and as will be described later, when the customer inputs the reservation number into the kiosk terminal 11 of the restaurant, the customer can make check-in at the restaurant. In addition, the scheduled date and time for the guidance and the event contents if an event is to be performed are also displayed. The information for identifying the reservation is not particularly limited, and may be various information such as a QR code (a registered trademark) and a barcode, for example, in addition to the reservation number as described above.

The method for generating such a reservation image is not particularly limited, and for example, a control language such as HTML (HyperText Markup Language) may be transmitted from the management system 2 or another reservation server (not illustrated) to the customer terminal 20. Then, the reservation image may be presented to the customer by interpreting the transmitted control language by browsing software or other application programs at the customer terminal 20.

The reservation reception unit 211 stores the restaurant name, the number of reserved customers, the reservation date and time, the reservation number, and the event contents as the reservation information 222 in the storage unit 22 of the reception device 201 by associating these information items with each other.

The image processing unit 212 decorates the image data (or the video data) transmitted from the customer. For example, if the event is a birthday celebration, image processing such as adding the word “Happy Birthday”, adding a decorative design, or creating a 3D image is performed on the transmitted image, and the image data after image processing (hereinafter, referred to as “processed image data”) is stored in association with the reservation information 222. In addition, the transmitted image data or the transmitted video data without performing image processing may be used as it is. For example, a decorative image such as a frame may be displayed in advance on the display device 89 as described later, and the transmitted image or the video may be superimposed on the decorative image. In addition, letters that were input by the customer at the time of the reservation as described above may be used when decorating the image.

The reservation information 222 generated as described above is transmitted to the restaurant management device 19. Further, various information other than the reservation information 222 may also be cross-referenced between the reception device 201 and the restaurant management device 19 and be stored in both the reception device 201 and the restaurant management device 19.

### 3-2. Accounting device

Next, the accounting device 202 may be a general-purpose personal computer, a dedicated computer, and the like. The accounting device performs accounting based on the number of plates input into the insertion port 331 and foods or drinks that were ordered through the touch panel display 14.

### 4. Check-in processing at the restaurant

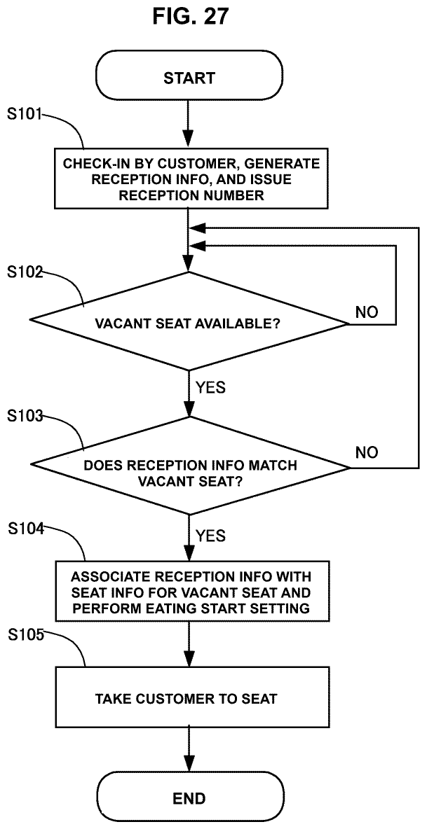

Next, a check-in process performed by the restaurant management device 19 will be described. First, the process with no reservation will be described with reference to FIG. 27. As shown in FIG. 27, when a customer enters a restaurant and performs a check-in through the kiosk terminal 11, the entry check-in unit 1911 generates the reception information 1922 and issues the reception number (Step S101). Then, the vacancy processing unit 1912 performs a vacancy setting and when a vacancy seat is available (YES at Step S102), the seat setting unit 1913 confirms whether the reception information 1922 conforms to the condition of the vacancy seat. For example, the vacancy processing unit 1912 checks the check-in order and determines whether the number of customers, etc., matches the condition of the vacant seat (i.e., the number of customers is equal to or less than the maximum number of persons for the vacant table). Then, when the reception information 1922 matches the condition of the vacant seat (YES at Step S103), the reception information 1922 and the seat information 1923 on the vacant seat are associated with each other, and performs an eating start setting (Step S104). Thereafter, the customer is guided to the vacant table 13 (Step S105).

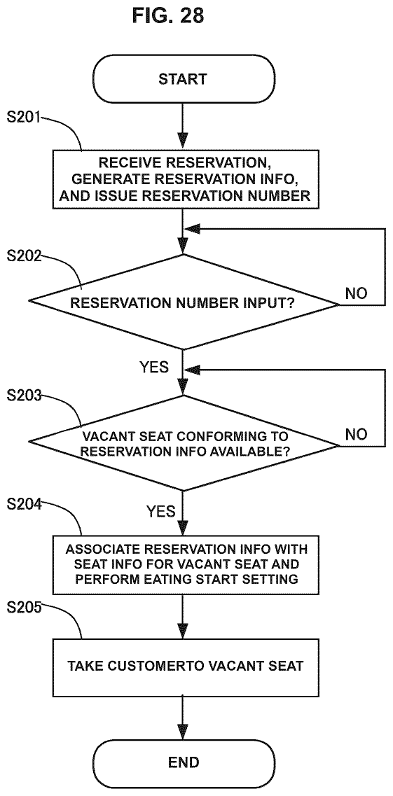

Next, the process with a reservation will be described with reference to FIG. 28. As shown in FIG. 28, when a customer makes a reservation through the customer terminal 20, the reservation reception unit 211 accepts the reservation and generates the reservation information 222 (Step S201). Further, the customer terminal 20 is notified of identification information such as the reservation number. Next, when the customer enters the restaurant and the reservation number is input into the kiosk terminal 5 (YES at Step S202), the entry check-in unit 1911 adds an entry flag to the reservation information 222. Then, the seat setting unit 1913 confirms whether a vacant seat conforming to the reservation information 222 is available, and if a vacant seat is available (YES at Step S203), the seat setting unit 1913 associates the reservation information 222 with the seat information 1923 related to the vacant seat and performs an eating start setting. Then, the customer is guided to the vacant table 13 (Step S205).

### 5. Processing of an event

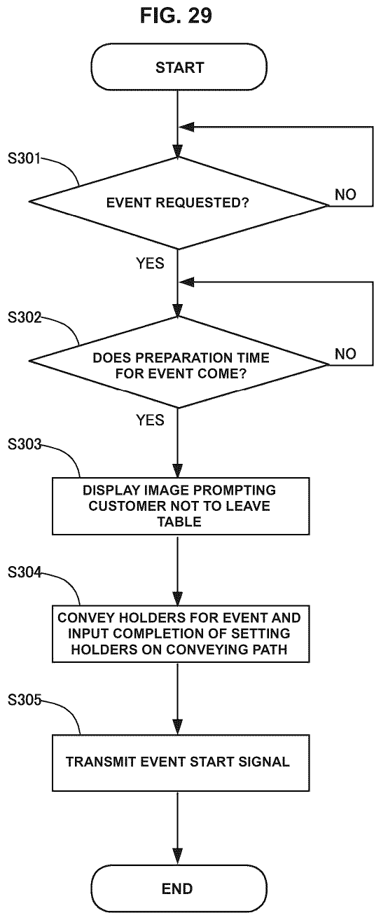

Next, the processing on an event will be described with reference to the flowchart of FIG. 29. As described above, the event will be performed for the customer who requested the event at the time of making a reservation. The reservation information 222 on the customer whom the event will performed includes the contents of the event, the image to be displayed, and the present. Furthermore, the reservation information 222 is associated with the seat information 224. Thus, the event can be properly performed at the table 13 for the customer who made the reservation, and his/her companion(s). Hereinafter, a method for performing the event will be described.

The restaurant staff operates the restaurant management device 19 to confirm the customer who made the reservation for the event (Step S301), and if the reservation includes a request for performing the event (YES at Step S301), the restaurant staff confirms a preparation time for that event. The preparation time for the event may be set in various ways. For example, the preparation time may be a time when a predetermined time has elapsed after the customer who made a reservation for the event is seated at the table 13 and starts placing an order through the touch panel display 14. Restaurant staffs may be automatically notified of the preparation time of the event by the restaurant management device 19 by displaying the time or outputting an audio voice, or the like.

When the preparation time for the event comes (YES at Step S302), the restaurant management device 19 displays a message on the touch panel display 14 at the target table 13 to request the customer(s) not to leave the table 13. For example, such a message “The event will start, so please do not leave the table 13” may be displayed (Step S303). That is, prior notice regarding the event may be made before the event starts at the table 13.

Next, the restaurant staff places the present 99 selected by the customer on the plate 4 in the first holder 101 and sets the display device 89 on the second holder 102. When both the holders 101 and 102 are prepared, the restaurant staff starts conveying these holders 101 and 102 by the conveying path 12, and inputs information that setting of the holders 101 and 102 is completed into the restaurant management device 19 (Step S304).

Subsequently, the controller 191 of the restaurant management device 19 (i.e., the first holder setting unit 1914 and the second holder setting unit 1915) estimates a time at which both the holders 101, 102 will pass through the target table 13 for the customer based on the conveyance speed of the flat chain conveyor 121 of the conveying path 12 and the seat information 1923 for the target table 13 for the customer by referring to the reservation information 222 of the customer. Then, the controller 191 transmits the event start signal to the control device 87 connected to the first holder 101 when the estimated time comes. Further, the second holder setting unit 1915 transmits the image data of the processed image to the display device 89. Further, when audio data for a voice message is set, the audio data is also transmitted.

When the event start signal is transmitted at the timing both the holders 101 and 102 pass through the target table 13, the control unit 87 controls the actuator 501 to open the lid body 7 of the first holder 101 to show (or disclose) the present 99 therein to the customers at the table 13. Further, the display device 89 displays the processed image and outputs an audio voice for the event. As the timing of opening the lid body 7 and the timing of displaying the processed image, for example, the lid body 7 may be opened after displaying the processed image. On the other hand, after opening the lid body 7, the processed image may be displayed, or both actions may occur at the same time.

### 6. Features

According to the food providing system as described above, the following advantageous effects can be obtained.
(1) For customers who want to have an event such as a celebration or a birthday party, the holders 101 and 102 conveyed on the conveying path 12 can be used to provide a present and display an image for the celebration so that the customers can be impressed.
(2) Since the lid body 7 of the first holder 101 is configured to open automatically, the lid body 7 can be opened at the proper timing the first holder 101 arrives at the table 13 for the customer. Thus, the lid body 7 is automatically opened in front of the customers, and the present 99 appears. Therefore, in addition to displaying an image on the display device 89, it is possible to provide an impression that shakes the customer's heart by physically presenting the analog performance (i.e., presenting the tangible present).

In this case, the lid body 7 is opened automatically after the image or the like is displayed by the display device 89. Therefore, since an analog performance is presented after an image or the like is displayed, the analog performance shaking the customer's heart can be presented more effectively. The lid body 7 may be opened while the image or the like is being displayed, or the lid body 7 may be opened after displaying the image or the like is completed.
(3) Since the event is performed by displaying the image previously transmitted from the customer on the display device 89, it is possible to hold a specific event specifically customized by each customer, which is not a generally created event.

### 7. Modifications

As described above, one embodiment of the present invention has been described, but the present invention is not limited thereto, and various changes are possible as long as the purpose is not deviated. The following modifications can be appropriately combined.
(1) In the above embodiment, a tablet computer or smartphone was used as the display device 89. The image data of the processed image transmitted from the restaurant management device 19 is displayed or an audio voice related to the audio data is output by the tablet computer or the smartphone. However, various changes can be made to the method for displaying an image. For example, the control unit 87 and the display device 89 are connected to each other by wire or wireless, and image data and audio data are stored in advance in the display device 89. Then, when the control unit 87 receives the event start signal, the control unit 87 can display the processed image on the display device 89 or output an audio voice. Further, the event start signal may be transmitted to the control unit 87 and the display device 89, and the lid body 7 may be opened and an image or the like may be displayed on (and an audio voice may be output from) the display device 89 upon receiving the event start signal. In this case, the first holder setting unit 1914 and the second holder setting unit 1915 can be a single module.

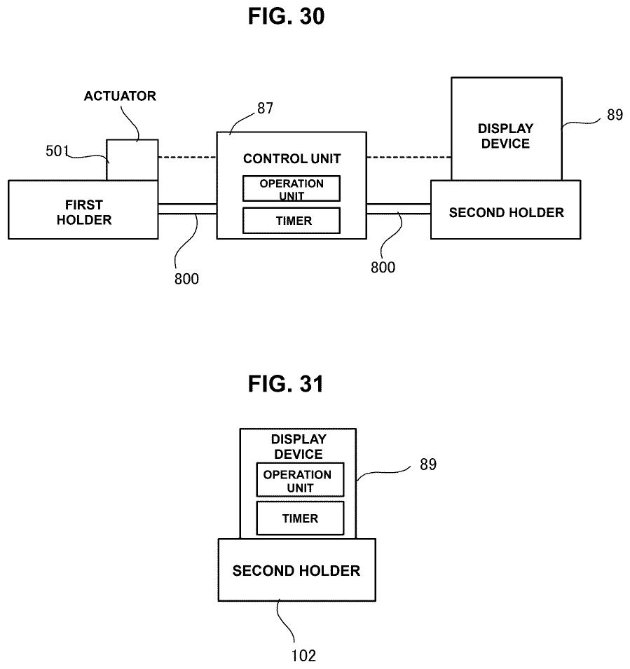

In the above embodiment, an event is started by transmitting the event start signal, but other methods may be used. For instance, as shown in FIG. 30, the control unit 87 has a built-in timer, and the timer may be set when both the holders 101, 102 are placed on the conveying path 12 such that an actuator (or a display device) is operated at a timing the holders 101, 102 pass through the target table. In this case, an operation device (for example, an operation switch, a touch panel) for inputting seat information on the seat for which an event is performed may be included in the control unit 87, and a timer may be set according to the seat information input by the operation device. The operation device is not necessarily built into the control unit 87. For example, the operation device may be connected to the control unit 87 by wired or wireless connection, and may be conveyed together with the control unit 87 on the conveying path 12. Further, when the operation device is connected to the control device wirelessly, the operation device may be a device such as a touch panel in the restaurant.

For example, a restaurant staff confirms the seat information on the table 13 for the customer using the restaurant management device 19. Next, the restaurant staff inputs the seat information on the seat (i.e., the target table) for which the event is performed using the operation device, and the timer is set with the time suitably calculated for the target table. Afterwards, both the holders 101,102 are conveyed on conveying path 12 and the control unit 87 operates the actuator (or the display device) at the input timing when the holders 101, 102 pass through the target table. As a result, the lid body 7 is automatically opened (or at least one of an image or a video for the event is displayed). The seat information may be, for example, a table number or a seat position information, but is not necessarily limited these as long as the target seat can be identified.

Also, when a tablet computer or smartphone is used as the display device 89, an application with a timer as shown in FIG. 31 that can be executed by the tablet computer or smartphone may be used. That is, without using the control unit 87 as described above, the timing of displaying an image or video can be set using a timer or an operation device (i.e., input means) built into the display device 89. For instance, when the seat information on the target seat for which an event is performed is input through input means (e.g., a touch panel or various buttons) of a tablet computer or smartphone, the timer in the application is set in accordance with the input seat information. Thereafter, at least one of an image or a video for the event is displayed on the display device 89 at a timing the holders pass through the target table by performing the application with the timer.

In addition, a display terminal such as a tablet computer or a smartphone is used as the display device 89, the application with the timer for displaying the image or the like at a predetermined timing is performed by a processor of the display device, while the control unit (e.g., a controller with a micro-computer, or a PLC) to open the lid body 7 of the first holder 101 at the predetermined timing and a timer are used. Therefore, the simplified structure and control can be used for the holder 101, while a general-purpose display terminal is effectively used. In this case, the control unit 87 can have the same hardware configuration (the control unit and the storage unit) as the restaurant management device 19 described above, and the control unit can be configured to control the actuator 501 when the first holder 101 passes through the target table assigned to the customer based on the seat information stored in the storage unit. Further, without using the control unit 87, a controller such as a PLC having a processor can be included in the first holder 101, and the actuator can be driven at a predetermined timing by this controller.

As described above, in the present embodiment, when an event (e.g., opening the lid, displaying an image) is performed based on the seat information stored in the storage unit 22, the event at the table may be performed by the seat information that is automatically input or the seat information that is input via an operation unit as an input device.

In the system of the above embodiment, when opening the lid body 7 of the holder 101 and displaying an image or the like on the display device 89 are executed, the control device (the controller) may be executed by different multiple processors or may be executed by a single processor.

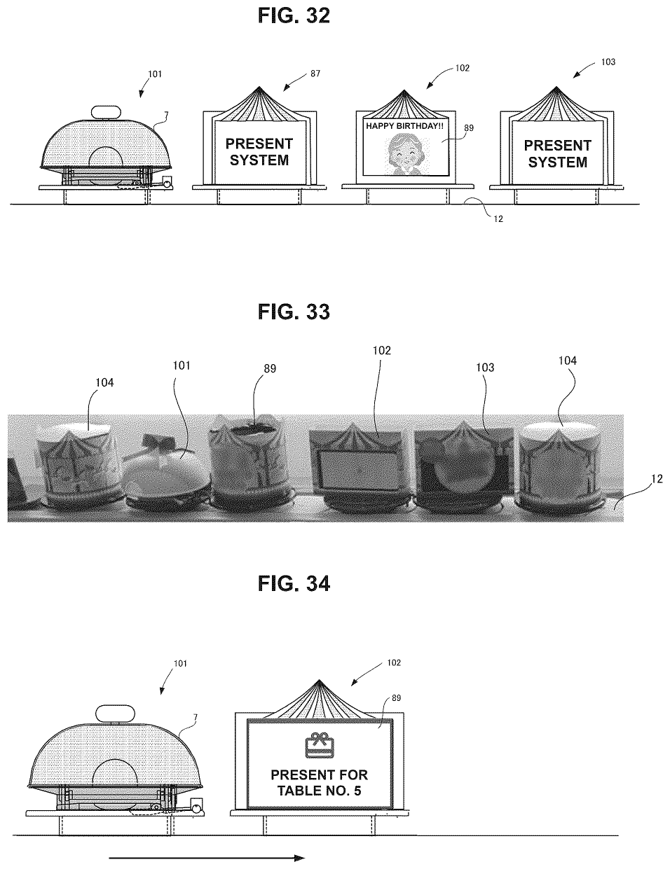

FIG. 32 is a diagram illustrating a system in operation according to an embodiment, and the speaker 103, the second container 102, the control unit 87, and the first holder 101 are conveyed in a row on the conveying path 12 in a conveying direction (from the right to the left in FIG. 32). A decoration is made to each item on the conveying path 12 as shown in FIG. 32. In the second holder 102, a smartphone is used as an example of the display device 89.

The lid body 7 of the first holder 101 includes a member having opaque characteristics so that a present inside is invisible to customers when the lid body 7 is closed (for example, an opaque cover may be attached to the lid body 7, the material of the lid body 7 itself may have opaque properties, or an opaque coating may be applied to the lid body 7). Usually, a transparent or translucent lid body 7 is used so that a present inside is visible, but in this case, if the present inside is visible, the customer cannot be effectively surprised by the event. Therefore, when the lid body 7 is made opaque, the present inside cannot be seen with the lid being closed. When the lid body 7 is opened, the present inside can be seen, so the customer can be effectively surprised.

FIG. 33 illustrates another example. As shown in FIG. 33, in this example, in addition to the example shown in FIG. 32, decorative items 104 are placed on the upstream side and the downstream side of the holders 101, 102 on the conveyance path 12. Each decorative item 104 may be formed, for example, of a paper or resin material designed for performing a celebration, which is conveyed on a base such as the mounting base 6 described above. However, the design of the decorative item is not necessarily limited to this, and various changes are applied. In addition, items to be conveyed are not particularly limited, and at least one of the above items (including at least one of the first holder 101 and the second holder 102) may be conveyed.

In the above embodiment, at the start of the event, the restaurant staff inputs, into the restaurant management device 19, information that the first and second holders 101 and 102 has been set on the conveying path 12. Alternatively, the event start process may be performed when, for example, a sensor detects that either one of the first holder 101, the second holder 102, or the control device is placed on the conveying path 12 or passes through a particular point on the conveying path 12. In this case, a position for starting the event may be automatically set on the conveying path 12 based on the seat information. Alternatively, a position for starting the event may be set on the conveying path 12 upon receiving an input of the seat information via an operation device.

The second holder 102 may display, on the display image 89, a message or an image to prompt the customers to pay attention to the first holder 101 and to take out the present from the first holder when the first and second holders 101, 102 are conveyed to the target table. FIGS. 34 to 38 are diagrams illustrating a system with displayed examples by a display device according to the present embodiment. In the examples of FIGS. 34 to 38, the second holder 102 on which the display device 89 is placed is located at a position upstream of the first holder 101 on which a present as a present is housed. In these examples, the control unit 87 is not illustrated. At the step of displaying an image or the like on the display device 89, the control unit 87 may display at least one of an image and a video associated with the step of opening the lid body 7 of the holder 101 (hereinafter, referred to as an “image, or the like.”).

As the image or the like associated with the step of opening the lid body 7 of the holder 101, an image that prompts the customers to pay attention to the holder 101 may be displayed before the lid body 7 is opened. Since attention is paid to the holder 101 before the lid body 7 is opened because of the image or the like, the customers can avoid missing the event (i.e., opening the lid body 7).

As the image or the like associated with the step of opening the lid body 7 of the holder 101, an image that prompts the customers to take the present in the holder 101 may be displayed after the lid body 7 was opened. Such an image can reduce the possibility that the present (the present) passes through the customers and be conveyed to another table without being taken out by the customers.

As the image or the like associated with the step of opening the lid body 7 of the holder 101, an image for celebrating the customer may be displayed when the present carried by the holder 101 is a present for celebration. Accordingly, the event of opening the lid body 7 can be made more exciting. Also, without limiting to this, an indication may be displayed to inform the customers of the contents of the present carried by the holder 101.

More specifically, as shown in FIG. 34, the display device 89 may display a message that the present is for a particular table for which the event is performed at a timing prior to the first and second holders 101, 102 arriving at the target table for the event. This allows other customers to know which table the event will be performed for.

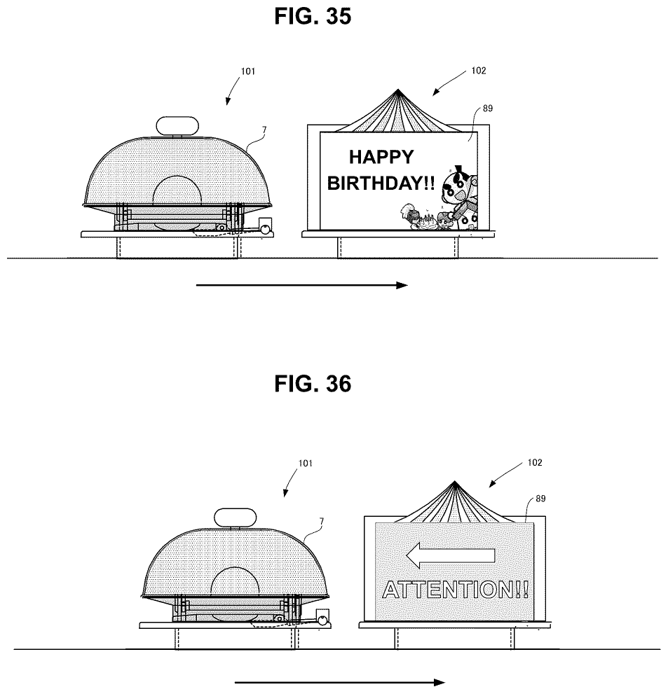

When the first holder 101 and the second holder 102 reach the target table, the event starts. As shown in FIG. 35, the display device 89 displays an image celebrating the customer (e.g., at least one of a congratulatory message, a diagram, or a picture may be displayed). Thereafter, as shown in FIG. 36, an image or the like (for example, at least one of a message, a diagram, or a picture) that prompts the customers to pay attention to the first holder 101 is displayed on the display device 89. As the image or the like that prompts the customers to pay attention, an arrow directing to the first holder 101 may be displayed.

The control unit 87 performs control to the lid body 7 so that the lid body 7 is opened after the image or the like that prompted the customers to pay attention to the first holder 101 as shown in FIG. 36 is displayed on the display device 89. That is, the timing for starting displaying the image or the like on the display device 89 and the timing of opening the lid body 7 of the first holder 101 have been properly adjusted in advance. As such, after the image or the like that prompts the customers to pay attention to the first holder 101 was displayed, the lid body 7 is opened.

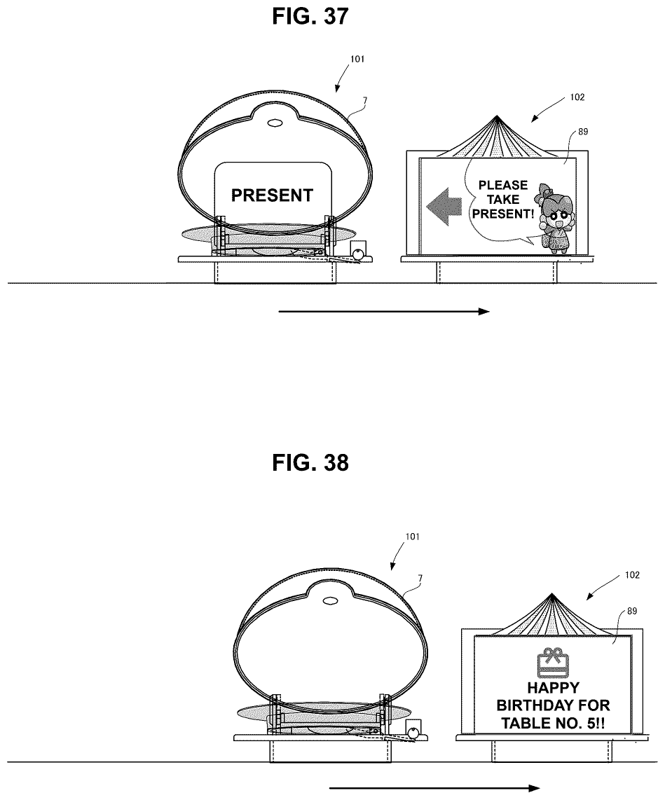

After the lid body 7 is opened, the display device 89 displays the image or the like (for example, at least one of a message, a diagram, or a picture) that prompts the customer to take out the present (the present) from the holder 101 as shown in FIG. 37. Thereafter, when both the holders 101 and 102 pass through the target table for which the event was performed and move to another table, as shown in FIG. 38, the display device 89 displays a message or the like that the event has been performed at the target table.

In the above description, the image or the like associated with the step of opening the lid body 7 of the first holder 101 is displayed, but an audio voice may be also output according to the displayed image or the like. Furthermore, without using the images, etc., only an audio voice may be used. As the audio voice, for example, the same voice message as the displayed message may be output.

In the above description, an event, an image, or the like were selected, by customers, but is not necessarily limited to this example, and an event may be performed when a customer takes a specific food or drink. Further, only a single, fixed event content or a single, fixed image without options may be applied to the present disclosure.
(3) In the above-described embodiment, both the first and second holders 101 and 102 are conveyed on the conveying path 12 at the event, but only one of them may be used. Further, the arrangement order of the first holder 101 and the second holder 102 on the conveying path 12 may be appropriately changed. Furthermore, the first holder 101 and the second holder 102 are not necessarily conveyed in a row, and may be conveyed with a predetermined distance or a predetermined interval.
(4) The configuration of the first holder 101 described above is one example and is not particularly limited. That is, the holder 101 may have a lid body 7 that covers the present, and the lid body 7 may be configured to automatically open at a predetermined timing. The first holder 101 described above houses a plate 4, but the present may be placed directly on the holder 101 without the plate 4. In addition, the lid body 7 of the first holder 101 may be configured to open by a customer operation in place of the above-described manner where the lid body 7 is automatically opened. For example, the lid body 7 may be configured to open when a customer holds his/her hand over a sensor or the hand touches the sensor, for example. Alternatively, the lid body 7 may also be opened manually by the customer. When the lid body 7 is opened by the customer's operation, it is preferable to display letters or a diagram prompting the customers to open the lid body 7 on the touch panel display 14. Alternatively, it is preferable to put such a message or diagram (i.e., a display) on the first holder 1. In this case, one of the holders 101, 102 or the control device 87 may have a sensor, and the sensor may detect, based on the seat information for the target table, the target table when the first holder 101 arrives at the target table. Then, the lid body 7 may be opened in response to the sensor detecting the target table, whereby the lid body 7 is prevented from opening when the holder 101 passes through other non-target tables.
(5) The configuration of the second holder 102 described above is also an example, and for example, the configuration of the mounting portion 62 may be different from that of the first holder 101, and may have a configuration to support at least the display device 89. Further, when the display device 89 does not have an audio function, a speaker may be separately provided in the mounting portion 62 or a speaker itself may be conveyed on the conveying path 12 (see, for example, FIG. 32 described later). Further, the mounting portion 62 and the display device 89 may be integrally formed. Further, the control unit 87 described above may also be incorporated into the first holder 101 and the second holder 102.
(6) The above-described normal holder (i.e., a container) 1 for conveying a food or a drink (or a beverage) is a holder without the actuator 501 of the first holder 101 and other parts are the same as the first holder 101. However, the normal holder 1 may have another configuration as long as the holder 1 serves as a plate on which a food or a drink can be placed.
(7) When performing an event, the touch panel display 14 disposed in the table 13 may display a message or diagram for the event. For example, messages such as “Happy Birthday”, designs, and the like may be displayed. Such messages may be input by customers when making a reservation as described above.
(8) Various images, videos, and audio data for events that are not prepared by a customer may be stored in advance in a storage of at least one of the reception device 201 and the restaurant management device 19, and events may be performed using such various data stored in the storage.
(9) In the above embodiment, the management system is formed of two computers, i.e., the reception device 201 and the accounting device 202, but the number of computers constituting the system is not particularly limited.

Further, in the above embodiment, for convenience of explanation, the reception device 201, the accounting device 202, and the restaurant management device 19 have been described separately, but the functional configuration of these devices may be realized by a single computer or multiple computers. Further, the position where these devices are placed is not necessarily limited, and may be arranged at at least one or more positions in each restaurant or management facility. Further, although the various processes described above are realized by a computer having a general-purpose CPU, a part or all of the processing may be realized by one or a plurality of dedicated processors.
(10) The reservation image displayed at the customer terminal 20 and the check-in image displayed at the kiosk terminal 11 shown in the above embodiment are one example, and various modifications can be applied. For example, items other than the items as described above may be input.
(11) In the above embodiment, at least one of event contents, a video or image, and a present may be selected through the touch panel display 14 on the table 13, In this case, at least one of an event where the lid body 7 of the holder 1 housing the selected present is opened and an event where the display device 89 displays at least one of the selected video and the selected image may be performed when the holder 1 passes through the target table 13 having the touch panel display 13 through which the customer made selections. Further, an audio voice may be selected, and the selected audio voice may be output at the time of the event.
(12) Further, in the above embodiment, at least one of the video and the image selected by the customer was displayed on the display device 89 conveyed on the conveying path 12. However, at least one of the video and the image that was selected by the customer terminal may be displayed on the touch panel display 14 disposed in the target table at a timing a particular present arrives at the target table.
(13) In the above embodiment, an event is performed at the timing the holder 1 conveyed by the conveyance path 12 passes through the target table 13, but is not limited thereto. For example, when a serving robot that autonomously moves on the floor of a restaurant arrives at the target table 13, at least one of a video and an image selected by the customer may be displayed on a display device as an event. In this case, the display device may be, for example, a touch panel 14 provided on the table 13, or a display device disposed in the serving robot.
(14) In the above embodiment, the food providing system in the present disclosure is applied to a delivery system for a conveyor-belt sushi restaurant. However, foods, beverages other than sushi may be delivered. Further, the above-described configuration of the conveying path and the configuration of the customer seat booth are one example and these configurations may be appropriately changed. In the above embodiment, the event is performed at the table 13 in which the customer's seats are arranged on both sides of the table 13, but the shape of the table and the position and number of customer seats are not particularly limited.

The present disclosure may include the following technical aspects.

A first aspect of the present disclosure is a food providing system having a conveying path that extends along customer's tables to convey a holder on which a food or a beverage is placed. The food providing system includes: a storage unit that is configured to store reservation information input by a customer, the storage unit further storing, in association with the reservation information, seat information on a table that is assigned to the customer in a restaurant; a first holder that includes a lid body, the first holder being conveyed on the conveying path with the lid body being closed; and a control unit that is configured to perform a first event step of opening the lid body as an event based on the seat information stored in the storage unit when the first holder passes through the table assigned to the customer.

A second aspect of the present disclosure is the food providing system according to the first aspect. The food providing system includes a second holder that is configured to support a display device while being conveyed on the conveying path. The storage unit is further configured to store, in association with the reservation information, at least one of an image and a video for the event that was received from the customer. The control unit is further configured to perform a second event step of controlling the display device to display the at least one of the image and the video based on the seat information.

A third aspect of the present disclosure is the food providing system according to the second aspect, wherein the first holder and the second holder are conveyed in a row on the conveying path.

A fourth aspect of the present disclosure is the food providing system according to the first aspect, wherein the first holder includes an actuator that selectively opens and closes the lid body, and at the first event step, the control unit is further configured to control the actuator to open the lid body when the first holder passes through the table assigned to the customer.

A fifth aspect of the present disclosure is the food providing system according to the first aspect, wherein the first holder houses a present that is to be presented to the customer at the event.

A sixth aspect of the present disclosure is the food providing system according to the second aspect, wherein the control unit is further configured to: control the display device to display the at least one of the image and the video at the second event step; and then open the lid body at the first event step.

A seventh aspect of the present disclosure is the food providing system according to the first aspect. The food providing system further includes an operation unit into which the seat information on the table at which the event is performed is input. The control unit is further configured to control, as the first event step, the lid body to open when a timer has counted a time set in accordance with the seat information input through the operation unit and when the first holder passes through the table assigned to the customer.

An eighth aspect of the present disclosure is the food providing system according to the second aspect. The food providing system further includes an operation unit into which the seat information on the table at which the event is performed is input. The control unit is further configured to control, as the second event step, the display device to display the at least one of the image and the video that is stored in the storage unit when a timer has counted a time set in accordance with the seat information input through the operation unit and when the second holder passes through the table assigned to the customer.

A ninth aspect of the present disclosure is the food providing system according to the second aspect. The control unit includes a first processor that is programmed to perform the first event step and a second processor that is programmed to perform the second event step

A tenth aspect of the present disclosure is the food providing system according to the second aspect. The control unit includes a single processor that is programmed to perform both the first and second event steps.

An eleventh aspect of the present disclosure is the food providing system according to the second aspect. The control unit is further configured to control, at the second event step, the display device to display the at least one of the image and the video that is associated with the first event step.

A twelfth aspect of the present disclosure is the food providing system according to the eleventh aspect. Prior to the lid body being opened, the control unit is further configured to control the display device to display, as the at least one of the image and the video that is associated with the first event step, an image prompting the customer to pay attention to the first holder.

A thirteenth aspect of the present disclosure is the food providing system according to the eleventh aspect. Subsequent to the lid body being opened, the control unit is further configured to control the display device to display, as the at least one of the image and the video that is associated with the first event step, an image prompting the customer to take out a present from the first holder.

A fourteenth aspect of the present disclosure is a method for performing an event on a conveying path that extends along customer's tables and conveys a holder on which a food or a beverage is placed. The method includes: storing reservation information received from a customer in a storage unit; storing, in association with the reservation information, seat information on a table that is assigned to the customer in a restaurant; conveying a first holder with a lid body being closed on the conveying path; and opening the lid body based on the seat information stored in the storage unit when the first holder passes through the table assigned to the customer.

A fifteenth aspect of the present disclosure is a food providing system with a conveying path that extends along customer's tables and conveys a holder on which a food or a beverage is placed. The food providing system includes: a storage unit that is configured to store reservation information input by a customer, the storage unit further storing, in association with the reservation information, seat information on a table that is assigned to the customer in a restaurant; a second holder that is configured to support a display device while being conveyed on the conveying path; and a control unit. The storage unit is further configured to store, in association with the reservation information, at least one of an image or a video for an event that was received from the customer. The control unit is further configured to perform a second event step of controlling the display device to display the at least one of the image and the video based on the seat information.

A sixteenth aspect of the present disclosure is a control device for a food providing system with a conveying path that extends along customer's tables and conveys a holder on which a food or a beverage is placed. The control device includes: a storage unit that is configured to store reservation information input by a customer, the storage unit further storing, in association with the reservation information, seat information on a table that is assigned to the customer in a restaurant; and a control unit. A first holder having a lid body and an actuator that is configured to open the lid body is conveyed on the conveying path with the lid body being closed. The control unit is configured to control the actuator to open the lid body based on the seat information stored in the storage unit when the first holder passes through the table assigned to the customer.

1. A food providing system having a conveying path that extends along customer's tables to convey a holder on which a food or a beverage is placed, the food providing system comprising:
a storage unit that is configured to store reservation information input by a customer;
a seat setting unit that is configured to assign a table to the customer in a restaurant and store seat information on the table in association with the reservation information;
a first holder that includes a lid body, the first holder being conveyed on the conveying path with the lid body being closed; and
a first holder setting unit that is configured to cause the lid body to open as an event when the first holder passes through the table assigned to the customer.

2. The food providing system according to claim 1, further comprising:
an image processing unit that is configured to receive at least one of an image and a video for the event from the customer and store the at least one of the image and the video in the storage unit;
a second holder that is configured to support a display device while being conveyed on the conveying path; and
a second holder setting unit that is configured to cause the display device to display the at least one of the image and the video when the second holder passes through the table assigned to the customer.

3. The food providing system according to claim 2, wherein
the first holder and the second holder are conveyed in a row on the conveying path.

4. The food providing system according to claim 1, wherein the first holder includes:
an actuator that is configured to selectively open and close the lid body based on a setting set by the first holder setting unit, and
a battery that is configured to drive the actuator.

5. The food providing system according to claim 1, wherein
the first holder houses a present that is to be presented to the customer at the event.

6. The food providing system according to claim 2, wherein
the first holder setting unit is further configured to:
control the display device to display the at least one of the image and the video; and then
open the lid body.

7. A method for performing an event on a conveying path that extends along customer's tables and conveys a holder on which a food or a beverage is placed, the method comprising:
storing reservation information received from a customer in a storage unit;
assigning a table to the customer in a restaurant;
storing, in association with the reservation information, seat information on the table assigned to the customer;
conveying a first holder with a lid body being closed on the conveying path; and
opening the lid body when the first holder passes through the table assigned to the customer.

8. A food providing system with a conveying path that extends along customer's tables and conveys a holder on which a food or a beverage is placed, the food providing system comprising:
a storage unit that is configured to store reservation information input by a customer;
an image processing unit that is configured to receive at least one of an image and a video for an event from the customer and store the at least one of the image and the video in association with the reservation information;
a seat setting unit that is configured to assign a table to the customer in a restaurant and store, in association with the reservation information, seat information on the table assigned to the customer;
a second holder that is configured to support a display device while being conveyed on the conveying path; and
a second holder setting unit that is configured to cause the display device to display the at least one of the image and the video when the second holder passes through the table assigned to the customer.
